(19) United States
(12) Patent Application Publication
(10) Pub. No.: US 2010/0309552 A1
(43) Pub. Date: Dec. 9, 2010

(54) RETARDATION FILM

(75) Inventor: Takahiro Takagi, Kanagawa (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA OPTO, INC., Tokyo (JP)

(21) Appl. No.: 12/866,772

(22) PCT Filed: Jan. 19, 2009
(86) PCT No.: PCT/JP2009/050649

§ 371 Date: Aug. 9, 2010

(30) Foreign Application Priority Data
Feb. 12, 2008 (JP) 2008030208

(51) Int. Cl. G02B 5/30

(52) U.S. Cl. 359/500

(57) ABSTRACT

Provided is a retardation film having an excellent front contrast. It is possible o measure a scattered light intensity of a film of a 90-degree incident light of a scattered light profile by a goniophotometer. Provided is retardation film characterized in that the difference between the scattered light intensity integration values obtained when the film slow axis is arranged horizontally and vertically on a sample table is 0.1 or below in measurement to detect a scattered light intensity at the position of 95 to 165 degrees from a light source.

### FIELD OF THE INVENTION

The present invention relates to a retardation film used for a liquid crystal display, and, in more detail, relates to a retardation film exhibiting an excellent front contrast.

### BACKGROUND OF THE INVENTION

A cellulose ester film, a polycarbonate film, a polycycloolefin film, and so on has been widely used as a retardation film for a liquid crystal display.

It is required for a retardation film that its transparency should be optically high and also its birefringence should be low. Specifically, in recent years, the size of a liquid crystal display becomes lager and the luminance becomes higher. In connection with these, an improvement in front contrast has become more severely demanded than before.

In order to improve the front contrast, an improvement in transmittance of each member constituting a liquid crystal display has been examined continuously. However, also the improvement in transmittance has been continuously examined about a retardation film at the cell side of a polarizing plate without exception.

For example, in Non-Patent Document 1, a single sheet technique employing a polycarbonate film or a polycycloolefin film has been proposed. However, even if such a technology is used, as an optical compensation film which simultaneously serves as a polarizing plate protective film, only insufficient pasting property with a polyvinyl alcohol film used as a polarizer film has been obtained, and a polarizing plate protective film consisting of a cellulose ester film has been recognized to be an indispensable optical film in a liquid crystal display even now

Then, it has been studied to provide a function of a retardation film to the cellulose ester film which shows a excellent property as a polarizing plate protective film.

Basically, a cellulose ester film has been used as a polarizing plate protective film because it shows a low birefringent property. Accordingly, it may not be easy to provide the function to a cellulose ester film.

In order to acquire a desired retardation value, a technique to add a compound having a retardation increasing effect to a cellulose ester film and to further stretch the film has been proposed (Patent Documents 1, 2, 3), however, there has been a problem that the transmittance of the film is deteriorated by stretching.

The transmittance deterioration of a film is presumed to be due to an increase in haze (which may be a reason of scattering), which may cause deterioration of the front contrast of a liquid crystal display.

Therefore, it has been eagerly desired to simultaneously provide a desired retardation value and a reduced haze to a cellulose ester film, when the cellulose ester film is used as a retardation film.

Patent Document 1: Japanese Patent Application Publication Open to Public Inspection (hereafter referred to as JP-A) No. 2006-299171

Patent Document 2: JP-A No. 2006-154803

Patent Document 3: JP-A No. 2006-265382

Non Patent Document 1: Japanese Liquid Crystal Society Journal Liquid Crystal “Various functional films for liquid crystal display elements” Special edition Vol. 9, No. 4 (2005)

### DISCLOSURE OF THE INVENTION

### Problems to be Solved by the Invention

An object of the present invention is to provide a retardation film exhibiting excellent visibility (with respect to light leakage, unevenness in color hue and front contrast).

### Means to Solve the Problems

The above-mentioned object of the present invention can be attained by the following structures.

(1) A retardation film exhibiting a difference between:

an integrated scattered light intensity determined when the retardation film is mounted on a sample stand of a goniophotometer so that a slow axis of the retardation film is horizontally aligned; and

an integrated scattered light intensity determined when the retardation film is mounted on the sample stand so that the slow axis of the retardation film is vertically aligned, of 0.1 or less, wherein

each integrated scattered light intensity is determined by integrating scattered light intensities at positions in the range of 95-165° from a light source in a scattered light profile of the goniophotometer in which an incident light angle onto the retardation film is 90°.

(2) The retardation film of Item (1), wherein the retardation film is a cellulose ester film comprising at least one of an aromatic terminal polyester compound represented by Formula (I) and an ester compound having one or more but 12 or less of at least one of a pyranose structure and a franose structure, provided that all or a part of OH groups in the structure are esterified,

B-(G-A)n-G-B Formula (I)

wherein B represents an aryl carboxylic acid residue, G represents an alkylene glycol residue having 2-12 carbon atoms, an aryl glycol residue having 6-12 carbon atoms or an oxyalkylene glycol residue having 4-12 carbon atoms, A represents an alkylene dicarboxylic acid residue having 4-12 carbon atoms or an aryl dicarboxylic acid residue having 6-12 carbon atoms, n represents an integer of 1 or more.

### Effect of the Invention

According to the present invention, a retardation film exhibiting an excellent front contrast can be obtained.

### BRIEF DESCRIPTION OF THE DRAWINGS

FIGS. 1a and 1b each are a schematic drawing of a goniophotometer.

### EXPLANATION OF NUMERALS

1 Light source lamp

2 Spectroscope

3 Sample stand (stage)

4 Sample

5 Photo receiver

θ Angle between normal direction of light source and a line connection observing point in the sample and integrating sphere

### PREFERRED EMBODIMENT OF THE INVENTION

Although the best modes for carrying out the present invention will be explained below in detail, the present invention is not limited thereto.

As mentioned above, viewing angle characteristics exist generally in a liquid crystal display, and when the liquid crystal display is observed from a position having an angle from the direction of a normal line of a liquid crystal cell, there has been a problem that the contrast deteriorates.

In order to solve the problem of viewing angle characteristics, it has been known that it is effective to provide a cellulose ester film having a retardation effect between a liquid crystal cell and a polarizer.

Generally, it is desirable that a retardation in the in-plane direction (Ro) is in a range of 20 to 200 nm, and a retardation in the thickness direction (Rt) is in a range of 70 to 400 nm. It is also desirable that the cellulose ester film which is the retardation film of the present invention has retardations in the above ranges.

Here, Ro =(nx·ny)×d

Rt=((nx+ny)/2−nz)×d

(In these formulas, nx represents a refractive index in a slow axis direction in a plane of a retardation film, ny represents a refractive index in a direction perpendicular to the slow axis in the plane, nz represents a refractive index in the thickness direction and d represents the thickness (nm) of the retardation film respectively. The measuring wavelength for each refractive index is 590 nm.)

The above-described refractive index can be determined by the use of, for example, KOBRA-21ADH (manufactured by Oji Instrument Co., Ltd.) at a wavelength of 590 nm under an environment of 23° C. and 55% RH.

### <Scattered Light Measured by a Goniophotometer>

Even if the retardation film of the present invention is subjected to a stretching process in order to obtain the above-mentioned retardation, it is characterized that the scattered light measured by the goniophotometer exists in a specified range.

Although it had been thought to be necessary to reduce haze of a cellulose ester film in order to improve the front contrast, it has been learned that the desired front contrast cannot always be obtained only by the reduction of the haze due to light going straight.

On the other hand, the present inventor has found that it is necessary to eliminate anisotropic scatter. The anisotropic scatter means a difference in scattered light intensity between the slow axis direction of a film and the direction perpendicular to the slow axis direction. This anisotropic scatter can be measured by a goniophotometer.

### <Measuring Device for Anisotropic Scatter>

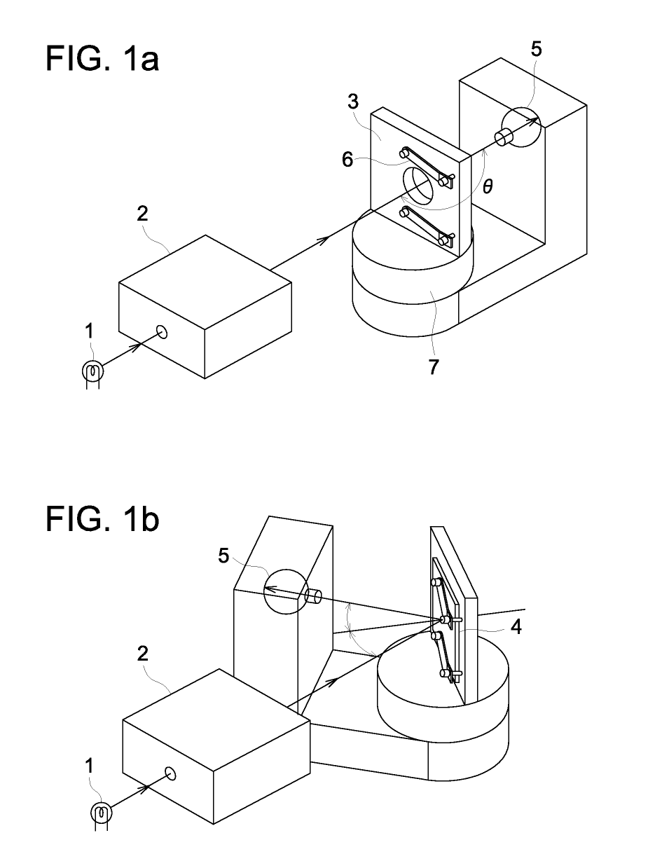

The outline of a goniophotometer (type: GP-1-3D, manufactured by Optic Corporation) is shown in FIGS. 1a and 1b. The goniophotometer contains a light source ramp 1, a spectroscope 2, a sample stand 3 (it is also called a stage), a sample 4, and a light receiver 5.

A 12V50W halogen lamp is employed as a light source, and a photomultiplier tube (Photomul, Hamamatsu photonics: R636-10) is employed as a light receiver.

FIG. 1a shows an arrangement of a light source lamp, a spectroscope, a sample stand (stage), and an integrating sphere to measure the intensity of light at the time of the reference measurement to measure reference light or at the time of measuring transmittance.

FIG. 1b shows an arrangement of the light source lamp, the spectroscope, the sample stand, and the integrating sphere at the time of measuring the reflectance of a sample placed on the sample stand.

The sample stand is usually of a vertically hooking type of a sample, and the sample is fixed with a pressing clip and an angle detecting rotating table is provided below the sample stand. The sample stand is structured such that transmittance and reflectance can be measured by a step of varying the angle between a sample plane and a light incident plane.

The anisotropic scattered light intensity according to the present invention can be measured by the arrangement showing in FIG. 1a, Namely, the scattered light intensity measurement for a film with an incident light at 90° in a scattered light profile of the goniophotometer means to measure the scattered light intensity when light is provided perpendicularly to a sample from the light source of the goniophotometer.

The measurement to detect a scattered light intensity at positions in the range of 95°-165° from the light source means to determine the integrated value of the scattered light intensities in the range of 95°-165° of angle θ which is an angle between the direction of normal line of the light source and a line connecting the observation point in the sample and the integration sphere as shown in FIG. 1a.

The present invention is characterized in that the difference between: an integrated scattered light intensity determined when the retardation film is mounted on a sample stand of a goniophotometer so that a slow axis of the retardation film is horizontally aligned; and an integrated scattered light intensity determined when the retardation film is mounted on the sample stand so that the slow axis of the retardation film is vertically aligned, is 0.1 or less, in the measurement of the integrated scattered light intensities at positions of which angle θ is in the range of 95°-165°.

An usual level can be used in order to obtain the horizontal and vertical conditions.

Various angles may be chosen as angle θ, however, in the present invention, the integrated scattered light intensity was obtained by summing up the scattered light intensities determined in every 1° in the range of 130°±35°, where 130° was an angle at which the correlation with the front contrast which is the final evaluation item as a liquid crystal display was highest.

The integrated scattered light intensities when the retardation film is mounted on the sample stand so that the slow axis of the retardation film is horizontally aligned and when the retardation film is mounted so that the slow axis of the retardation film is vertically aligned are in the range of 0.1-4.0, preferably 1.0 or less and more preferably 0.50 or less.

The difference in the integrated scattered light intensities are preferably as small as possible. Further, the scattered light intensities when horizontally aligned and when vertically aligned are preferably 1.0 or less.

In order to attain the scattered light intensity of the present invention, it is preferable that the retardation film of the present invention is a cellulose ester film containing at least one of an aromatic terminal polyester compound represented by Formula (1) and an ester compound having one or more but 12 or less of at least one of a pyranose structure and a franose structure, provided that all or a part of OH groups in the structure are esterified,

B-(G-A)n-G-B Formula (I)

wherein B represents an aryl carboxylic acid residue, G represents an alkylene glycol residue having 2-12 carbon atoms, an aryl glycol residue having 6-12 carbon atoms or an oxyalkylene glycol residue having 4-12 carbon atoms, A represents an alkylene dicarboxylic acid residue having 4-12 carbon atoms or an aryl dicarboxylic acid residue having 6-12 carbon atoms, n represents an integer of 1 or more.

### <Cellulose Ester>

The cellulose ester utilized in the present invention is not specifically limited, however, the cellulose ester may be an ester with a carboxylic acid having around 2-22 carbon atoms or may be an ester with an aromatic carboxylic acid and is specifically preferably an ester with a lower fatty acid.

Acyl groups bonding to hydroxyl groups may either be a straight chain or a branched chain, or may form a ring. Further, acyl groups may be substituted by other substituents. When the substitution degree is the same, a larger number of carbon atoms results in decrease of birefringence of the cellulose ester. Accordingly, acyl groups having a carbon number of 2-6 are preferably selected. The number of carbon atoms as aforementioned cellulose ester is preferably 2-4 and more preferably 2-3.

Specifically, as a cellulose ester utilized in the present invention, mixed fatty acid ester of cellulose in which a propionate group or a butyrate group other than an acetyl group is bonded, such as cellulose acetate propionate, cellulose acetate butyrate or cellulose acetate propionate butyrate may be employed.

A butyryl group constituting butyrate may be either a straight chain or a branched chain. Cellulose ester specifically preferably utilized in this invention is cellulose acetate, cellulose acetate butyrate, cellulose acetate propionate or cellulose acetate phthalate.

Cellulose ester other than cellulose acetate phthalate used in the present invention preferably satisfies equations (1) and (2), simultaneously.

2.0≦X+Y≦3.0 Equation (1)

0≦Y≦1.5 Equation (2)

wherein, X is a susbstitution degree of an acetyl group, Y is a substitution degree of an propionyl group, a butyryl group or mixed groups thereof

Moreover, in order to obtain an optical characteristics matching with the object of the present invention, resins having different substitution degrees may be mixed. As the mixing ratio, 10:90 to 90:10 are preferable.

Among them, cellulose acetate propionate may be specifically preferably utilized. In cellulose acetate propionate, X is in 1.0≦X≦2.5, and it is preferable that Y and X+Y are 0.1≦Y≦1.5 and 2.0≦X+Y≦3.0. A substitution degree of an acyl group can be measured by a measurement method based on ASTM-D817-96.

The number average molecular weight of the cellulose ester utilized in the present invention is preferably in a range of 60,000 to 300,000 in view of the mechanical strength of the prepared film. Those having a number average molecular weight of 70,000 to 200,000 are more preferably utilized.

The weight average molecular weight Mw and the number average molecular weight Mn the of cellulose ester are determined by means of gel permeation chromatography (GPC).

The measurement condition will be shown below.

Solvent: Methylene chloride

Column: Shodex K806, K805, K803G (produced by Showa Denko K.K., 3 columns are connected to use)

Column temperature: 25° C.

Sample concentration: 0.1% by mass

Detector: RI Model 504 (produced by GL Sciences Inc.)

Pump: L6000 (produced by Hitachi Ltd.)

Flow rate: 1.0 ml/min

Calibration curve: Standard polystyrene STK (produced by Tosoh Corp.), a calibration curve obtained by using 13 samples in the Mw ranges of 1000000 to 500 is used. The 13 samples are of approximately the same intervals.

Cellulose as a starting material of cellulose ester utilized in the present invention is not specifically limited, and includes such as cotton linter, wood pulp and kenaf. Further, cellulose ester prepared from these materials may be utilized by mixing each of them at an arbitrary ratio.

The cellulose ester of the present invention such as cellulose acetate phthalate can be manufactured according to a known method. Specifically, the cellulose ester can be synthesized by referring the method described in JP-A No. 10-54804.

### (Aromatic Terminal Polyester Compounds Represented by Formula (1))

In the present invention, an aromatic terminal polyester compound represented by Formula (1) is employed.

B-(G-A)ₙ-G-B Formula (I)

In the above formula, B is an arylcarboxylic acid residue, G is an alkylene glycol residue having 2-12 carbon atoms, an aryl glycol residue having 6-12 carbon atoms or an oxyalkylene glycol residue having 4-12 carbon atoms, A is an alkylenedicarboxylic acid residue having 4-12 carbon atoms or an aryldicarboxylic acid residue having 6-12 carbon atoms, and n is an integer of 1 or more. The polyester compound is constituted by the arylcarboxylic acid residue represented by B, the alkylene glycol residue, the oxyalkylene glycol residue or the aryl glycol residue represented by G, and the alkylenedicarboxylic acid residue or the aryldicarboxylic acid residue represented by A; in Formula (I), and the compound can be obtained by a reaction similar to that for obtaining usual polyester compound.

Examples of an arylcarboxylic acid as a component of the aromatic terminal polyester compound used in the present invention include: benzoic acid, p-tert-butylbenzoic acid, o-toluic acid, m-toluic acid, p-toluic acid, dimethylbenzoic acid, ethylbenzoic acid, n-propylbenzoic acid, aminobenzoic acid and acetoxybenzoic acid. They can be employed solely or in combination of two or more kinds.

Examples of an alkylene glycol having 2-12 carbon atoms as a component of the aromatic terminal polyester compound used in the present invention include ethylene glycol, 1,2-propylene glycol, 1,3-propylene glycol, 1,2-butanediol, 1,3-butanediol, 1,2-propanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentane), 2-n-butyl-2-ethyl-1,3-propanediol (3,3-dimethylolheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol and 1,12-octadecanediol. These glycols are employed solely or in combination of two or more kinds thereof.

An alkylene glycol with 2-12 carbon atoms is particularly preferable since compatibility with cellulose ester is excellent.

Examples of an oxyalkylene glycol having 4-12 carbon atoms as a component of the above aromatic terminal polyester compound include diethylene glycol, triethylene glycol, tetraethylene glycol, dipropylene glycol and tripropylene glycol. These glycols can be employed singly or in combination of two or more kinds.

Examples of the alkylenedicarboxylic acid having 4-12 carbon atoms as a component of the aromatic terminal polyester compound include succinic acid, maleic acid, fumaric acid, glutaric acid, adipic acid, azelaic acid, sebacic acid and dodecanedicarboxylic acid. These acids can be employed solely or in combination of two or more kinds.

Examples of an arylenedicarboxylic acid component having 6 to 12 carbon atoms include phthalic acid, terephthalic acid, isophthalic acid, 1,5-naphthalenedicarboxylic acid and 1,4-naphthalenedicarboxylic acid.

The aromatic terminal polyester compound used in the present invention preferably has an n number of 1 or more but 100 or less, and a number average molecular weight of 300-1500 and more preferably 400-1000.

The acid value and the hydroxyl group value are 0.5 mg KOH/g or less and 25 mg KOH/g or less, respectively, and, preferably, 0.3 mg KOH/g or less and 15 mg KOH/g or less, respectively.

The aromatic terminal polyester compound represented by Formula (1) of the present invention is preferably contained 0.5-30% by mass based on the mass of the cellulose ester.

Specific examples of am aromatic terminal polyester compound usable in the present invention will be shown below, however, the present invention is not limited thereto.

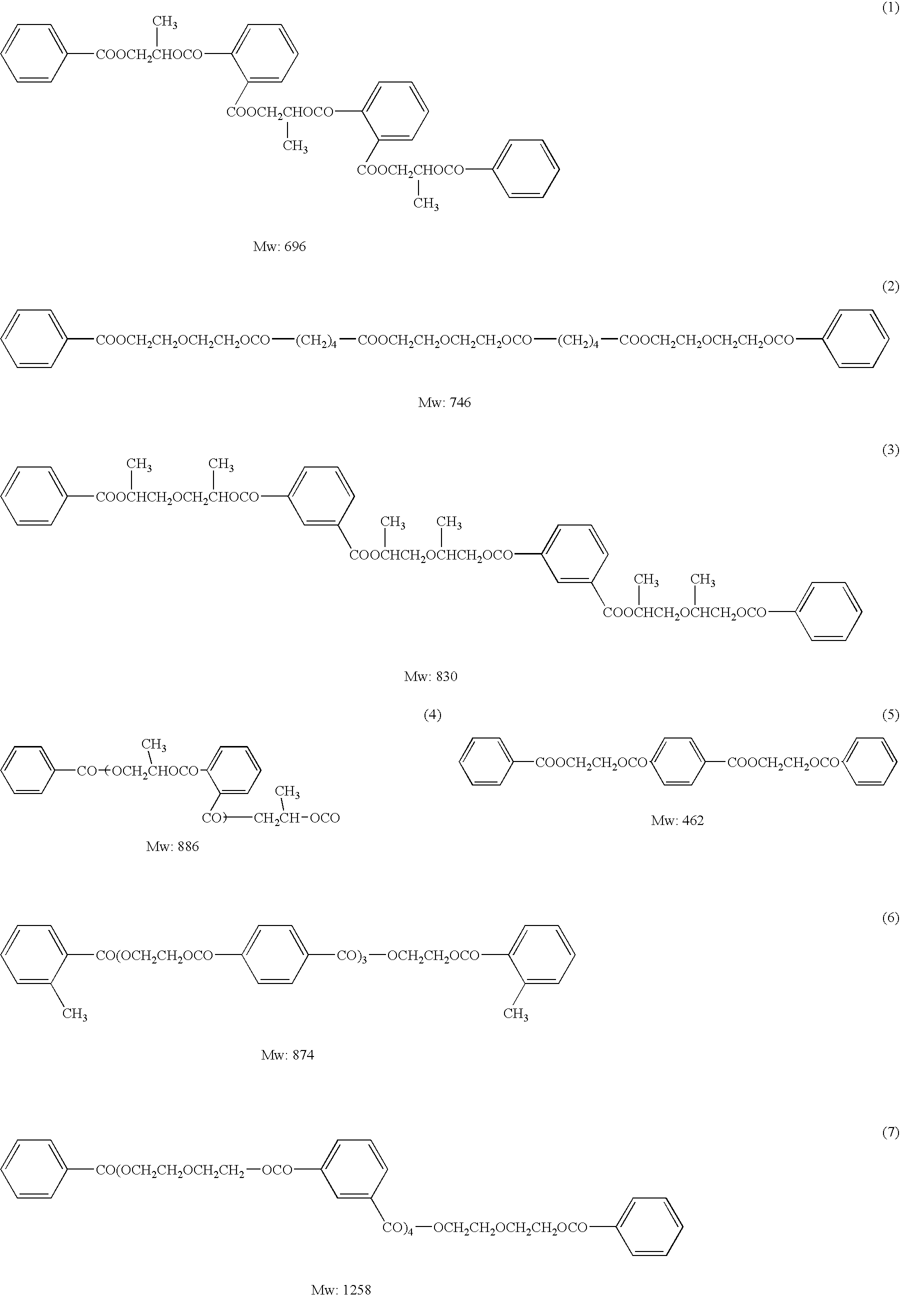

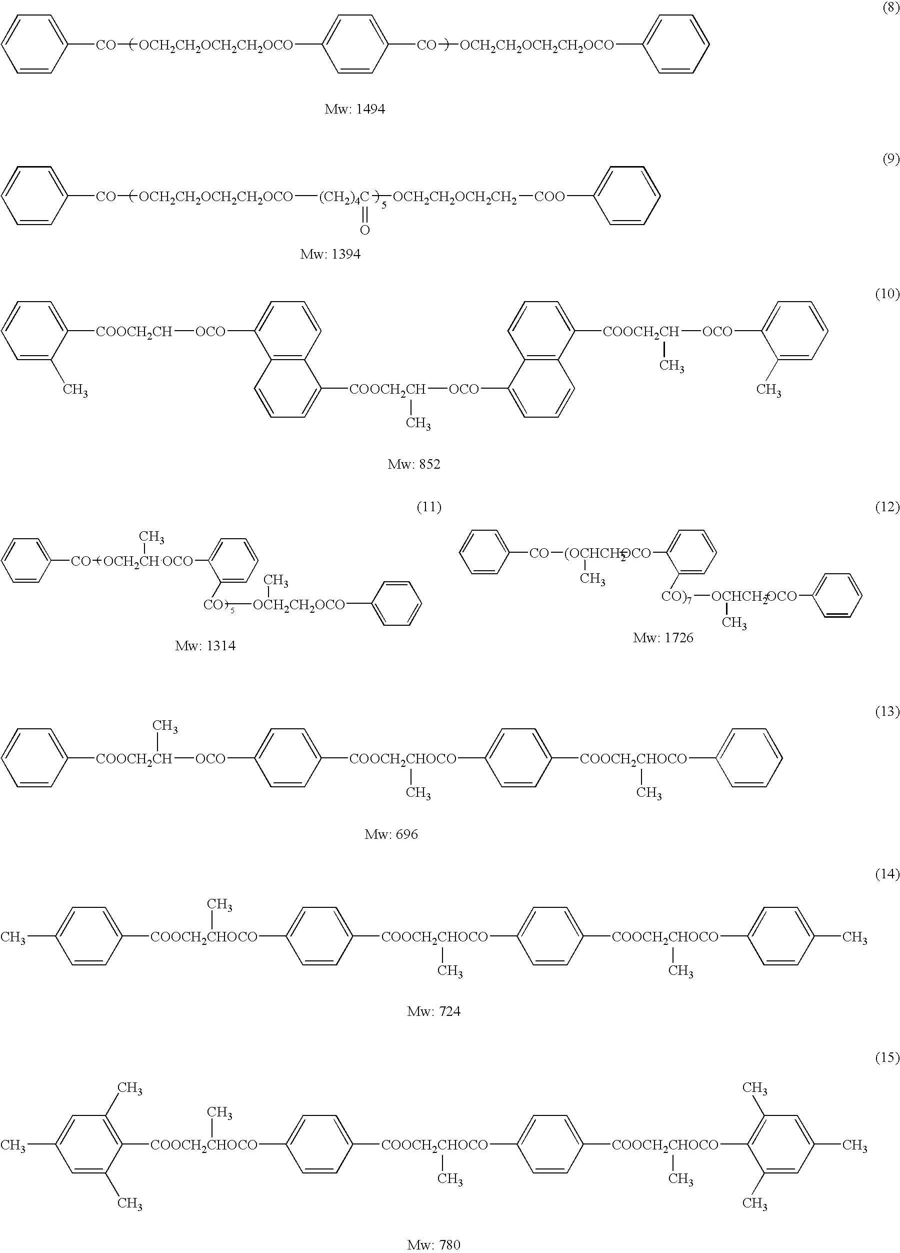

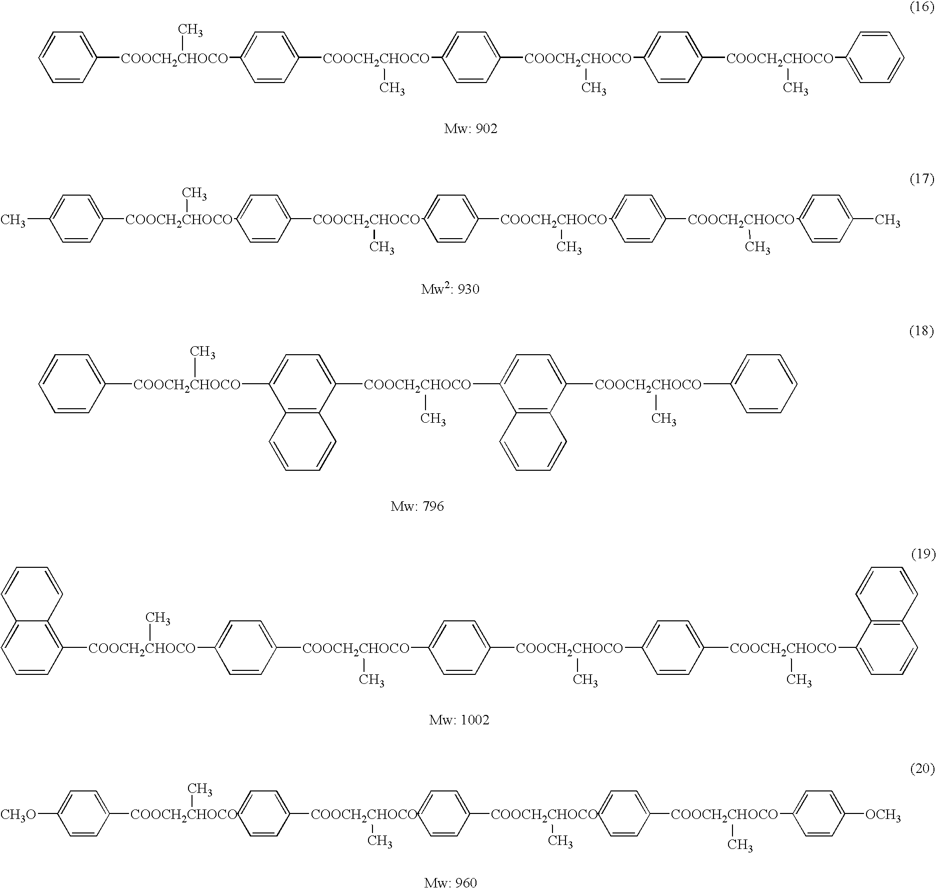

<<Ester Compound Having One or More but 12 L or Less of at Least One of a Pyranose Structure and a Franose Structure, Provided that All or a Part of OH Groups in the Structure are Esterified>>

The cellulose ester film of the present invention is characterized by containing a ester compound having one or more but 12 or less of at least one of a pyranose structure and a franose structure, provided that all or a part of OH groups in the structure are esterified.

With respect to the ratio of esterification, it is preferable that 70% or more of OH groups contained in the pyranose structure or the franose structure are esterified.

In the present invention, such ester compounds are also collectively referred to as saccharide ester compounds.

As examples of an ester compound of the present invention, the following materials may be cited, however, the present invention is not limited thereto.

Such examples include glucose, galactose, mannose, fructose, xylose, arabinose, lactose, sucrose, nystose, 1F-fructosylnystose, stachyose, maltitol, lactitol, lactulose, cellobiose, maltose, cellotriose, maltotriose, raffinose and kestose.

Further, gentiobiose, gentiotriose, gentiotetraose, xylotriose, and galactosyl-sucrose may be cited.

Among these compounds, a compound having both a pyranose structure and a fructose structure is preferably used.

Examples of such a compound include sucrose, kestose, nystose, 1F-fructosylnystose and stachyose, and further preferable is sucrose.

A monocarboxylic acid to be used to esterify all or a part of OH groups contained in the pyranose structure or the frunose structure is not specifically limited and known aliphatic monocarboxylic acid, alicyclic monocarboxylic acid and aromatic monocarboxylic acid may be used. The monocarboxylic acid may be used singly or in combination of two or more kinds thereof.

Examples of a preferable aliphatic monocarboxylic acid include saturated fatty acids such as acetic acid, propionic acid, butyric acid, isobutyric acid, valerianic acid, capronic acid, enanthic acid, caprylic acid, pelargonic acid, capric acid, 2-ethyl-hexanecarboxylic acid, undecylic acid, lauric acid, tridecylic acid, myristic acid, pentadecylic acid, palmitic acid, heptadecylic acid, stearic acid, nonadecanic acid, arachidic acid, behenic acid, lignoceric acid, cerotic acid, heptacosanoic acid, montane acid and melissic acid; and unsaturated fatty acids such as undecylic acid, oleic acid, sorbic acid, linolic acid, linolenic acid, arachidonic acid and octenic acid.

As examples of preferable aliphatic carboxylic acid, cyclopentene carboxylic acid, cyclohexane carboxylic acid, cycloctane carboxylic acid and derivatives thereof can be cited.

Examples of an aromatic monocarboxylic acid include aromatic monocarboxylic acids formed by introducing one to five alkyl or alkoxy groups into the benzene ring of benzoic acid such as benzoic acid and toluic acid; aromatic monocarboxylic acids having two or more benzene rings such as cinnamic acid, benzilic acid, biphenyl carboxylic acid, naphthalene carboxylic acid, tetralin carboxylic acid; and derivatives thereof. More concretely, xylic acid, hemellitic acid, mesitylenic acid, prehnitylic acid, γ-isodurylic acid, isodurylic acid, mesitoic acid, α-isodurylic acid, cuminic acid, α-toluic acid, hydratropic acid, atropic acid, cinnamic acid, hydrocinnarnic acid, salicylic acid, o-anisic acid, m-anisic acid, p-anisic acid, creosotic acid, o-homosalicylic acid, m-homosalicylic acid, p-homosalicylic acid, o-pyrocatechuic acid, β-resorcylic acid, vanillic acid, isovanillic acid, veratric acid, o-veratric acid, gallic acid, asaronic acid, mandelic acid, homoanisic acid, Homovanillic acid, homoveratric acid, o-homoveratric acid, phthalonic acid, p-coumaric acid may be cited. Among them, benzoic acid is specifically preferable.

An ester compound of oligosaccharide may be employed as a compound having 1-12 of at least one of a pyranose structure and a fructose structure of the present invention .

The oligosaccharide can be produced by acting a ferment such as amylase to, for example, starch or cane sugar. As an oligosaccharide usable in the present invention, malt oligosaccharide, isomalt oligosaccharide, fructo oligosaccharide, galacto oligosaccharide, and xylo oligosaccharide may be listed.

The aforementioned ester compound is a compound obtained by condensing one or more but 12 or less of at least one of a pyranose structure and a furanose structure represented by following Formula (A), wherein R₁-R₁₅ and R₂₁-R₂₅ each represent an acyl group having 2-22 carbon atoms or a hydrogen atom, m and n each represent an integer of 0-12, and m+n is an integer of 1-12.

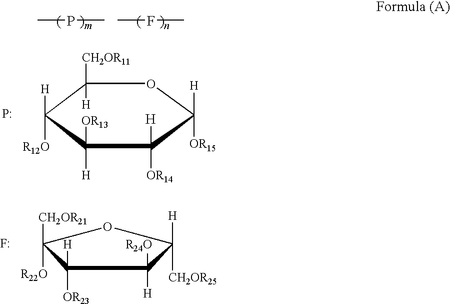

R₁₁ to ₁₅, R₂₁ to R₂₅ each are preferably a benzoyl group or a hydrogen atom. The benzoyl group may further have substituent R₂₆ (p is 0-5) examoles of which include such as an alkyl group, an alkenyl group, an alkoxy group and a phenyl group, and these alkyl group, alkenyl group and phenyl group may further have a substituent. The oligosaccharide can be prepared in a similar method to an esterified compound of the present invention.

Specific examples of an ester compound relating to the present invention will be shown below, however, the present invention is not limited thereto.

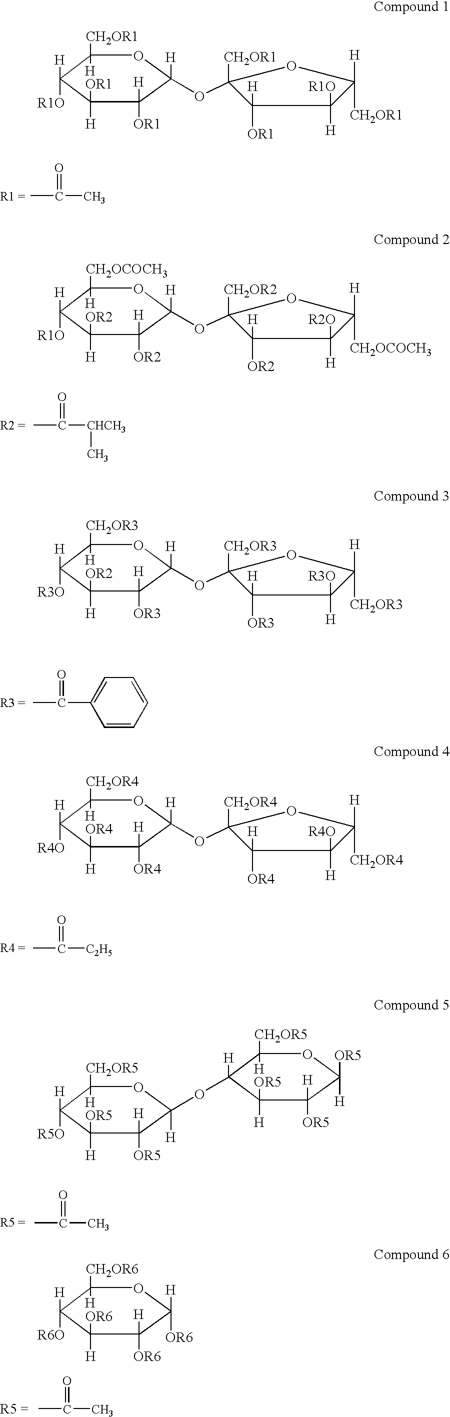

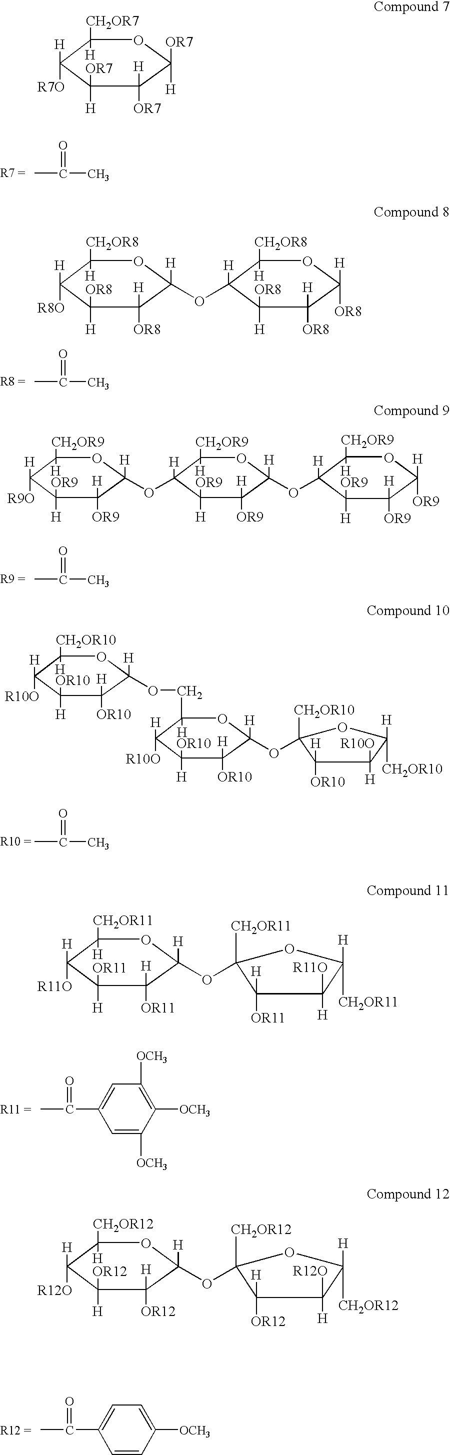

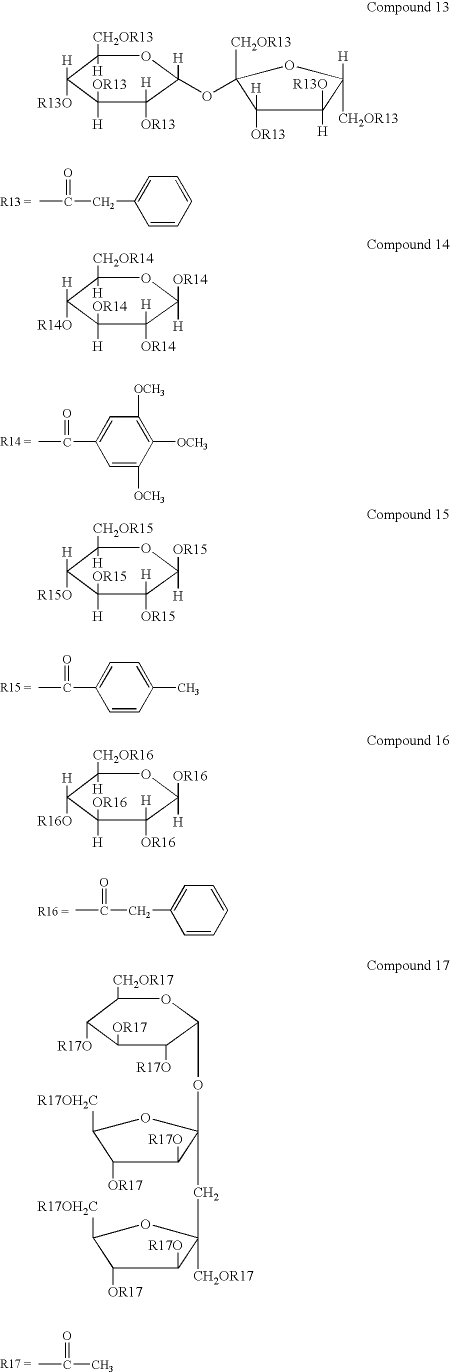

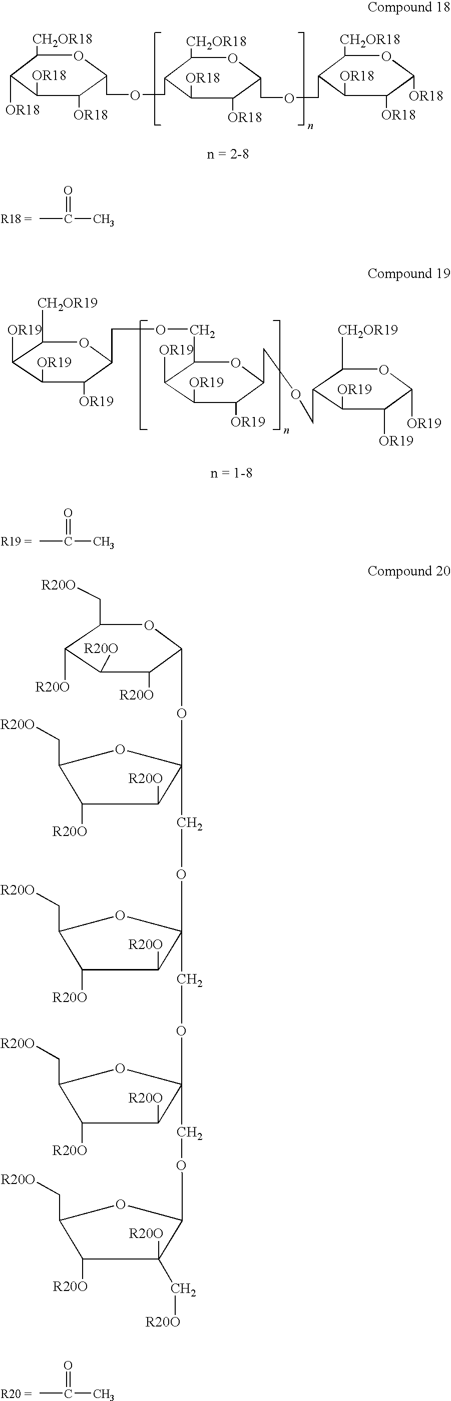

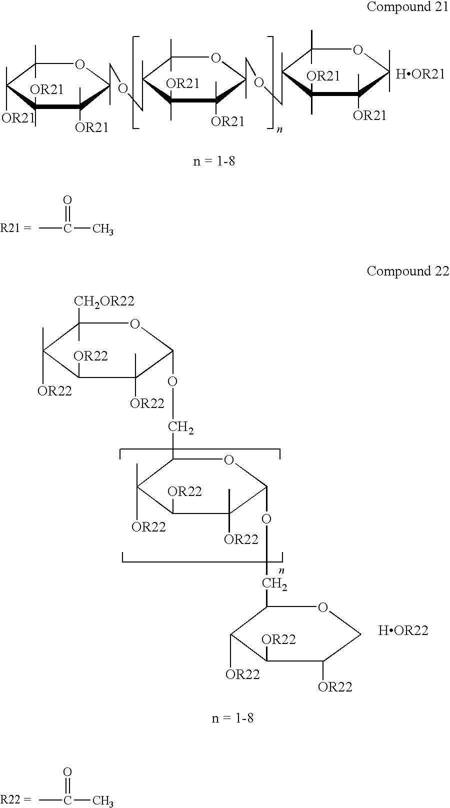

The cellulose ester film of the present invention preferably contains 0.5-30% by mass, and more preferably 5-30% by mass of a sugar ester compound according to the present invention based on the mass of the cellulose ester film, in order to stabilize the display quality by suppressing the variation of retardation values.

The ratio of the aromatic terminal polyester compound represented by Formula (1) of the present invention to the sugar ester compound can be selected in the range of 99:1-1:99 in a mass ratio, and the total content of the both compounds is preferably 1 to 40% by mass based on the mass of the cellulose ester.

### <Other Additives>

### (Plasticizer)

The cellulose ester film of the present invention may contain a plasticizer if needed, in order to obtain the effect of the present invention.

The plasticizer is not specifically limited, however, it is preferably selected from, for example, a polycarboxylic acid ester plasticizer, a glycolate plasticizer, a phthalate plasticizer, a fatty acid ester plasticizer, a polyalcohol ester plasticizer, a polyester plasticizer and an acrylate plasticizer.

Of these, when two or more plastcizers are used, it is preferable that at least one is a polyalcohol ester plasticizer.

A polyalcohol ester plasticizer is a plasticizer which is constituted of an ester of an aliphatic polyalcohol of divalent or more and a monocarboxylic acid, and it preferably has an aromatic ring or a cycloalkyl ring in the molecule. It is preferably an ester of an aliphatic polyalcohol having a valence of 2-20.

The polyalcohol preferably used in the present invention is expressed by following Formula (a).

R1—(OH)n Formula (a)

wherein, R1 represents an organic group having a valence of n, n represents an integer of two or more. The OH group means an alcoholic or a phenolic hydroxyl group.

As examples of a preferable polyalcohol, for example, the following compounds may be listed, however, the present invention is not limited thereto.

Examples of a preferable polyalcohol include: adonitol, arabitol, ethylene glycol, diethylene glycol, Methylene glycol, tetraethylene glycol, 1,2-propanediol, 1,3-propanediol, dipropylene glycol, tripropylene glycol, 1,2-butanediol, 1,3-butanediol, 1,4-butanediol, dibutylene glycol, 1,2,4-butanetriol, 1,5-pentanediol, 1,6-hexanediol, hexanetriol, galactitol, mannitol, 3-methylpentane-1,3,5-triol, pinacol, sorbitol, trimethylolpropane, trimethylolethane and xylitol.

Specifically, triethylene glycol, tetraethylene glycol, dipropylene glycol, tripropylene glycol, sorbitol, trimethylol propane and xylitol are preferable.

The monocarboxylic acid to be used in the polyalcohol ester is not specifically limited, and a known aliphatic monocarboxylic acid, an alicyclic monocarboxylic acid and an aromatic monocarboxylic acid may be employed. Specifically, an aliphatic monocarboxylic acid and an aromatic monocarboxylic acid are preferable, since moisture permeation is reduced and retainability is improved.

Examples of a preferable monocarboxylic acid will listed below, but the present invention is not limited thereto.

A straight or branched chain carboxylic acid having 1 to 32 carbon atoms is preferably employed. The number of carbon atoms is more preferably 1-20, and specifically preferably 1-10. The use of acetic acid is preferable for raising the compatibility with a cellulose ester, and the mixing of acetic acid with another carboxylic acid is also preferable.

As the preferable aliphatic monocarboxylic acid, saturated aliphatic acids such as acetic acid, propionic acid, butyric acid, valeric acid, caproic acid, enantic acid, caprylic acid, pelargonic acid, capric acid, 2-ethyl-hexane acid, undecylic acid, lauric acid, tridecylic acid, myristic acid, pentadecylic acid, palmitic acid, heptadecylic acid, stearic acid, nonadecanic acid, arachic acid, behenic acid, lignocelic acid, cerotic acid, heptacosanic acid, montanic acid, melisic acid and lacceric acid; and unsaturated aliphatic acids such as undecylenic acid, oleic acid, sorbic acid, linolic acid, linolenic acid and arachidonic acid, can be exemplified.

Examples of preferable alicyclic carboxylic acid include cyclopentane carboxylic acid, cyclohexane carboxylic acid, cyclooctane carboxylic acid and derivatives thereof.

Examples of preferable aromatic monocarboxylic acid include ones formed by introducing 1-3 alkyl groups, alkoxy groups such as methoxy groups or ethoxy groups into the benzene ring of benzoic acid such as benzoic acid and toluic acid; and an aromatic monocarboxylic acid having two or more benzene rings such as biphenylcarboxylic acid, naphthalene carboxylic acid and tetralin carboxylic acid, and derivatives thereof, of these, benzoic acid is specifically preferable.

The molecular weight of the polyalcohol ester is preferably 300-1500, and more preferably 350-750, though the molecular weight is not specifically limited. A larger molecular weight is preferable for storage ability, while a smaller molecular weight is preferable for compatibility with cellulose ester.

The carboxylic acid to be employed in the polyalcohol ester may be one kind or a mixture of two or more kinds of them. The OH groups in the polyhydric alcohol may be fully esterified or a part of OH groups may be left unreacted.

Specific examples of the polyalcohol ester will be listed below.

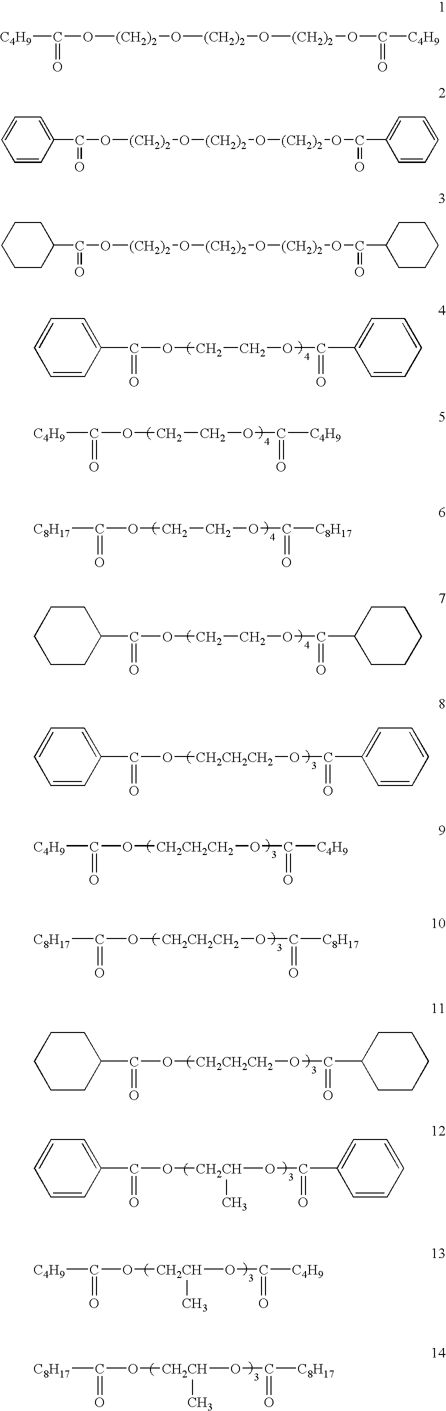

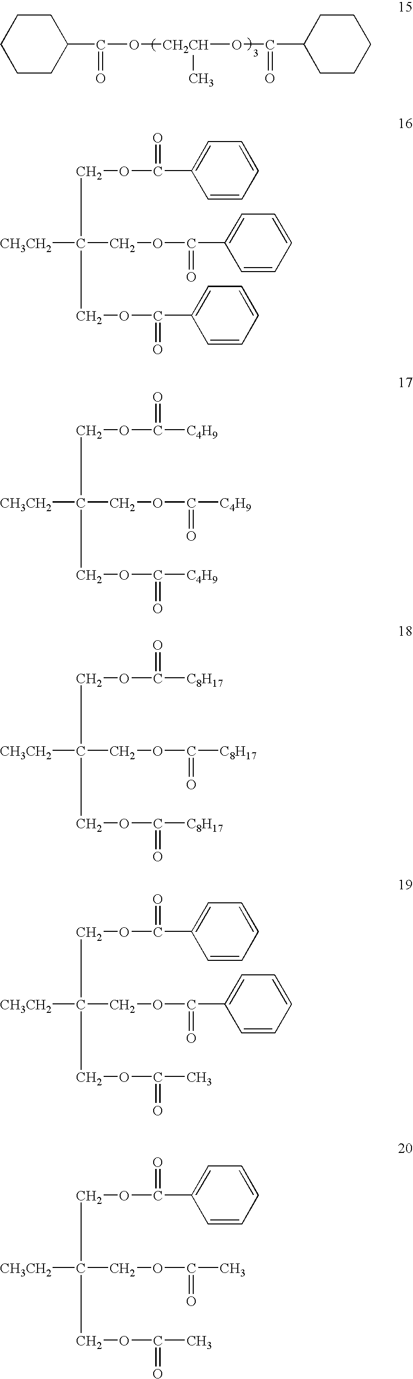

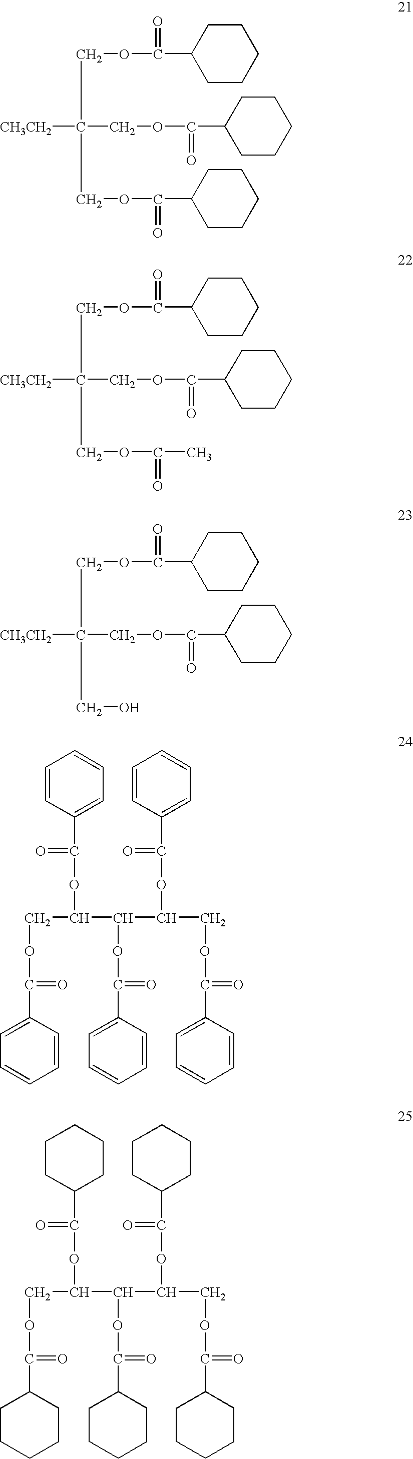

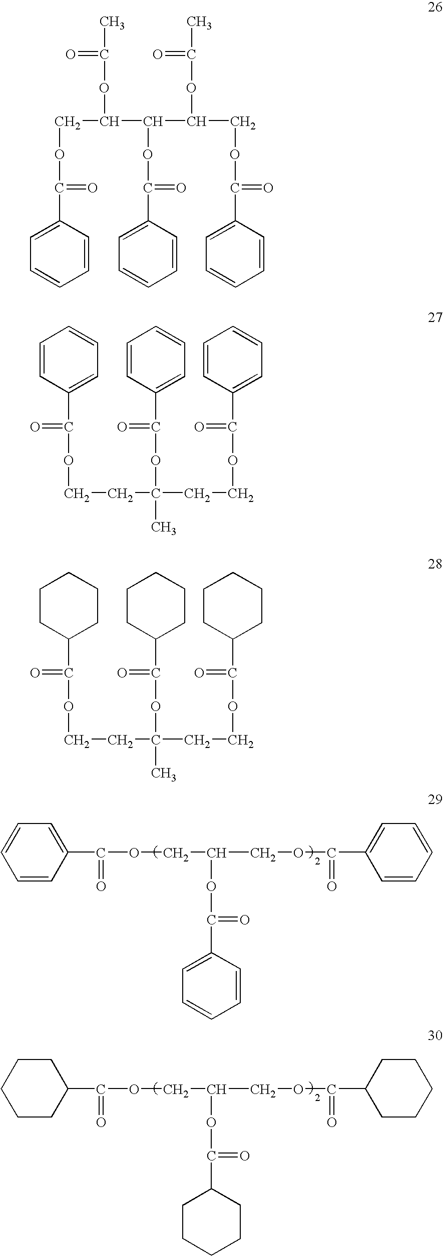

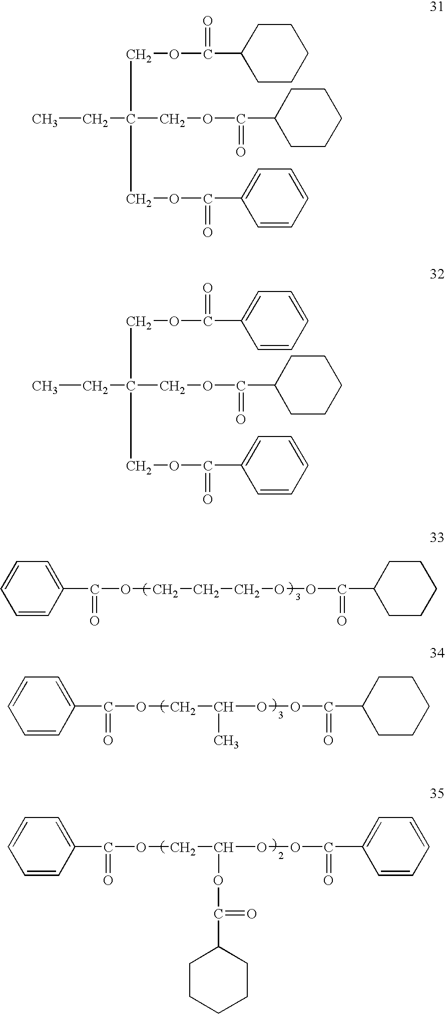

A glycolate type plastisizer is not specifically limited; however alkyl phthalyl alkyl glycolates may be preferably utilized.

Alkyl phthalyl alkyl glycolates include such as methyl phthalyl methyl glycolate, ethyl phthalyl ethyl glycolate, propyl phthalyl propyl glycolate, butyl phthalyl butyl glycolate, octyl phthalyl octyl glycolate, methyl phthalyl ethyl glycolate, ethyl phthalyl methyl glycolate, ethyl phthalyl propyl glycolate, methyl phthalyl butyl glycolate, ethyl phthalyl butyl glycolate, butyl phthalyl methyl glycolate, butyl phthalyl ethyl glycolate, propyl phthalyl butyl glycolate, butyl phthalyl propyl glycolate, methyl phthalyl octyl glycolate, ethyl phthalyl octyl glycolate, octyl phthalyl methyl glycolate and octyl phthalyl ethyl glycolate.

Examples of a phthalic acid ester plastisizer include such as diethyl phthalate, dimethoxy ethyl phthalate, dimethyl phthalate, dioctyl phthalate, dibutyl phthalate, di-2-ethylhexyl phthalate, dioctyl phthalate, dicyclohexyl phthalate and dicyclohexyl terephthalate.

Examples of a citric acid ester plastisizer include such as acetyl trimethyl citrate, acetyl triethyl citrate and acetyl tributyl citrate.

Examples of a fatty acid ester type plastisizer include such as butyl oleate, methyl acetyl ricinoleate and dibutyl cebacate.

Examples of a phosphoric acid ester plastisizer include such as triphenyl phosphate, tricresyl phosphate, cresyl diphenyl phosphate, octyl diphenyl phosphate, diphenyl biphenyl phosphate, trioctyl phosphate and tributyl phosphate.

The polycarboxylic acid ester plasticizer usable in the present invention includes an ester of alcohol and a polycarboxylic acid having a valence of 2 or more, but preferably having a valence of 2-20. The valence of an aliphatic polycarboxylic acid is preferably 2-20, and the valence of an aromatic polycarboxylic acid and an alicyclic polycarboxylic acid each are preferably 3-20.

The polycarboxylic acid is expressed by Formula (b).

R₂(COOH)ₘ(OH)ₙ Formula (b)

(wherein, R₂ represents an organic group having a valence of (m+n), m is a positive integer of two or more, and n is an integer of zero or more, COOH group represents a carboxyl group and OH group represents alcoholic or phenolic hydroxyl group.)

The following can be cited as an example of desirable polycarboxylic acid, however, the present invention is not limited thereto.

Examples of a polycarboxylic acid include: an aromatic polycarboxylic acid having a valence of 3 or more and its derivative, for example, trimellitic acid, trimesic acid, and pyromellitic acid; an aliphatic polycarboxylic acid, for example, succinic acid, adipic acid, azelaic acid, sebacic acid, oxalic acid, fumaric acid, maleic acid and tetrahydrophthalic acid; and an oxypolycarboxylic acid, for example, tartaric acid, tartronic acid, malic acid, and citric acid. Specifically, it is preferable to use oxypolycarboxylic acid with respect to the enhancement of retention properties.

There is no restriction in particular for an alcohol used for the polycarboxylic acid ester of the present invention, and well-known alcohol and phenol can be used.

For example, a saturated aliphatic alcohol or an unsaturated aliphatic alcohol with normal chain or branched chain having carbon atom number of 1 to 32 can be preferably used. The number of carbon atoms is more preferably from 1 to 20 and still more preferably from 1 to 10.

Moreover, an alicyclic alcohol and its derivative such as cyclopentanol and cyclohexanol, and an aromatic alcohol and its derivative such as benzyl alcohol and cinnamyl alcohol can be preferably used.

When using oxypolycarboxylic acid as polycarboxylic acid, the alcoholic or phenol hydroxyl group of the oxypolycarboxylic acid may be esterified by using monocarboxylic acid. Although the following compounds can be cited as examples of a preferable monocarboxylic acid, the present invention is not limited to these.

For aliphatic monocarboxylic acids, normal or branched fatty acids having 1 to 32 carbon atoms are preferably used. The number of carbon atoms is more preferably from 1 to 20 and still more preferably from 1 to 10.

Examples of a preferable aliphatic monocarboxylic acid include saturated fatty acids such as: acetic acid, propionic acid, butyric acid, valeric acid, caproic acid, enanthic acid, caprylic acid, pelargonic acid, capric acid, 2-ethyl- hexane carboxylic acid, undecylic acid, lauric acid, tridecylic acid, myristic acid, pentadecylic acid, palmitic acid, heptadecanoic acid, stearic acid, nonadecane acid, arachidic acid, behenic acid, ligrioceric acid, cerotinic acid, heptacosanoic acid, montanic acid, melissic acid, lacceric acid, as well as unsaturated fatty acids such as: undecylic acid, oleic acid, sorbic acid, linoleic acid, linolenic acid and arachidonic acid.

Examples of a preferable alicyclic monocarboxylic acid include: cyclopentanecarboxylic acid, cyclohexanecarboxylic acid, cyclooctanecarboxylic acid, and derivatives thereof.

Examples of a preferable aromatic monocarboxylic acid include: benzoic acid and toluic acid, both of which have benzene ring in which an alkyl group is introduced, biphenylcarboxylic acid, naphthalenecarboxylic and tetralincarboxylic acid each having 2 or more benzene rings, and derivatives thereof. Specifically, acetic acid, propionic acid and benzoic acid are preferred.

The molecular weight of the monocarboxylic acid ester compound is not specifically limited, however, the molecular weight is preferably from 300 to 1000 and more preferably from 350 to 750. A higher molecular weight is preferable with respect to the improvement in retention properties, while a lower molecular weight is preferable with respect to reducing moisture permeability, or to improving compatibility with cellulose ester.

The alcohol used for the polycarboxylic acid ester used for the present invention may be one kind, or a mixture of two or more kinds.

The acid value of a polycarboxylic acid ester compound used for the present invention is preferably 1 mgKOH/g or less, and more preferably 0.2 mgKOH/g or less. The acid value in the above range is preferable because the variation of retardation values due to environmental change can be suppressed.

“Acid value”, as described herein, refers to the amount of potassium hydroxide in mg, which is necessary to neutralize the acid (namely a carboxyl group existing in the sample) incorporated in 1 g of a sample. The acid value is determined based on JIS K0070.

Although the examples of an specifically preferable polycarboxylic acid ester compound will be shown below, the present invention is not limited thereto.

For example, listed are: triethyl citrate, tributyl citrate, acetyltriethyl citrate (ATEC), acetyltributyl citrate (ATBC), benzoyltributyl citrate, acetyltriphenyl citrate, acetyltribenzyl citrate, dibutyltartrate, diacetyldibutyl tartarate, tributyl trimellitate and tetrabutyl pyromellitate.

### (Ultraviolet Absorber)

The cellulose ester film B according to the present invention may contain an ultraviolet absorber. An ultraviolet absorber is aimed to improve durability by absorbing ultraviolet rays not longer than 400 nm. Specifically, the transmittance of light at a wavelength of 370 nm is 10% or less, more preferably 5% or less, and further more preferably 2% or less.

The ultraviolet absorber utilized in the present invention is not specifically limited and includes such as an oxybenzophnone compound, a benzotriazole compound, a sarycic acid ester compound, a benzophenone compound, a cyanoacrylate compound, a triazine compound, a nickel complex salt compound and an inorganic powder.

For example listed are 5-chloro-2-(3,5-di-sec-butyl-2-hydroxylphenyl)-2H-benzotriazole, (2-2H-benzotriazole-2-yl)-6-(straight chain and branched dodecyl)-4-methylphenol, 2-hydroxy-4-benzyloxybenzophenone and 2,4-benzyloxybenzophenone; and also listed and preferably utilized are Tinuvins, such as Tinuvin 109, Tinuvin 171, Tinuvin 234, Tinuvin 326, Tinuvin 327 and Tinuvin 328, which are available on the market from Ciba Specialty Chemicals.

Ultraviolet absorbers utilized in the present invention are preferably a benzotriazole ultraviolet absorber, a benzophenone ultraviolet absorber and a triazine t ultraviolet absorber, and specifically preferably a benzotriazole ultraviolet absorber and a benzophenone ultraviolet absorber.

In addition to these, a disc form compound such as a compound having a 1,3,5-triazine ring is preferably utilized as a UV absorber.

The polarizing plate protective film according to the present invention preferably contains two or more kinds of ultraviolet absorbers.

Further, a polymer ultraviolet absorber may also be preferably utilized as an ultraviolet absorber, and polymer type ultraviolet absorbents described in JP-A 6-148430 are specifically preferably utilized.

As an addition method of an ultraviolet absorber, a ultraviolet absorber may be added into a dope after having been dissolved in an organic solvent, for example, alcohols such as methanol, ethanol and butanol; organic solvents such as methylenechloride, methyl acetate, acetone and dioxane; and a mixed solvent thereof; or may be directly added into a dope composition.

Those insoluble in an organic solvent, such as inorganic powder, will be added into a dope after having been dispersed in an organic solvent and cellulose ester by use of such as a dissolver or a sand mill.

The using amount of an ultraviolet absorber is not uniform depending on a type and a using condition of an ultraviolet absorbent, however, in the case of the dry layer thickness of polarizing plate protective film of 30 to 200 μm, it is preferably 0.5 to 10 mass % and more preferably 0.6 to 4 mass%, based on the mass of the polarizing plate protective film.

### (Antioxidant)

An antioxidant is also called as a deterioration-preventing agent. When a liquid crystal display is stored in a high temperature-high humidity condition, the cellulose ester film may be deteriorated.

An antioxidant is preferably contained in the foregoing cellulose ester film since an antioxidant has a function to retard or prevent decomposition of the cellulose ester film due to, for example, halogen contained in the residual solvent in the cellulose ester film or a phosphoric acid contained in a phosphoric acid-containing plasticizer.

As an antioxidant, hindered phenol compounds are also preferably employed. Examples of a hindered phenol compound: 2,6-di-t-butyl-p-cresol, pentaerythityl-tetrakis[3-(3,5-di-t-butyl-4-hydroxyphenyl)propionate], triethylene glycol-bis[3-(3-t-butyl-5-methyl-4-hydroxyphenyl) propionate], 1,6-hexanediol-bis[3-(3,5-di-t-butyl-4-hydroxyphenyl)propionate], 2,4-bis(n-octyl)-6-(4-hydroxy-3,5-di-t-butylanilino)-1,3,5-triazine, 2,2-thio-diethylene-bis[3-(3,5tbutyl-4-h_{y}droxyphenyl) propionate], octadecyl-3-(3,5-di-t-butyl-4-hydroxyphenyl)propionate, N,N′-hexamethylene-bis(3,5-di-t-butyl-4-hydroxy-4-hydroxy-hydrocinnamide), 1,3,5-trimethyl-2,4,6-tris(3,5-di-t-butyl-4-hydroxybenzy)benzene and tris-(3,5-di-t-butyl-4-hydroxybenzyl)-isocyanurate.

Specifically, 2,6-di-t-butyl-p-cresol, pentaerythityl-tetrakis[3-(3,5-di-t-butyl-4-hydroxyphenyl)propionate] and triethylene glycol-bis[3-(3-t-butyl-5-methyl-4-hydroxyphenyl) propionate] are preferred. Further, a hydrazine metal inactivation agent such as N,N′-bis[3-(3,5-di-t-butyl-4-hydroxyphenyl)propionyl]hydrazine or a phosphorus-containing processing stabilizing agent such as tris(2,4-di-t-butylphenyl)phosphite may be used in combination.

The adding amount of such a compound is preferably 1 ppm to 1.0%, and more preferably from 10 ppm to 1,000 ppm by mass based on the mass of the cellulose derivative.

### (Particulates)

The cellulose ester film according to the present invention preferably contain particles.

With respect to the particles used in the present invention, examples of an inorganic compound include: silicon dioxide, titanium dioxide, aluminum oxide, zirconium oxide, calcium carbonate, calcium carbonate, talc, clay, calcined kaolin, calcined calcium silicate, hydrated calcium silicate, aluminum silicate, magnesium silicate and calcium phosphate. Particles of an organic compound are also preferably used. Examples of an organic compound include: pulverized and classified particles of, for example, polytetrafluoroethylene, cellulose acetate, polystyrene, polymethylmethacrylate, polypropylmethaciylate, polymethyl acrylate, polyethylene carbonate, an acrylic-styrene resin, a silicone resin, a polycarbonate resin, a benzoguanamine resin, a melamine resin, polyolefin powder, a polyester resin, a polyimide resin, polyethylenefluoride resin and starch. A polymer compound, synthesized via a suspension polymerization, and a polymer compound or an inorganic compound formed into spheres via a spray-drying method or a dispersion method are also usable.

Particles containing silicon are preferable with respect to decreasing turbidity, and silicon dioxide is specifically preferable.

The mean diameter of primary particles of the particles is preferably from 5 to 400 nm, and more preferably from 10 to 300 nm.

The particles should preferably exist as aggregated secondary particles of diameters of from 0.05 to 0.3 μm. When the mean diameter of the primary particles is 100-400 nm, the particles may also be preferably contained as primary particles without aggregating.

The content of the particles in a polarizing plate protective film is preferably from 0.01 to 1% by mass, and is more preferably from 0.05 to 0.5% by mass. In a multi-layered polarizing plate protective film prepared by a co-casting method, a major part of the particles should preferably exist near the surface.

Particles of silicon dioxide are available on the market, for example, under trade names of AEROSIL 8972, R927V, R974, R812, 200, 200V, 300, R202, OX50 and TT600 (manufacture by Nippon Aerosil Co., Ltd.)

Particles of zirconium oxide are available on the market, for example, under trade names of AEROSIL R976 and R811 (manufacture by Nippon Aerosil Co., Ltd.)

Particles of polymer available on the market include, for example: silicone resin, fluorine-contained resin and acrylic resin. Among these, silicone resin, especially three dimensionally networked silicone resin is preferably used. Examples of such silicone resins include: TOSPERL 103, 105, 108, 145, 3120 and 240, which are manufactured by Toshiba Silicone Co., Ltd.

Among the particles listed above, AEROSIL 200V and AEROSIL R972V are particularly preferable with respect to exhibiting a lower friction coefficient while maintaining the low turbidity. The kinetic friction coefficient of at least one surface of the polarizing plate protective film used in the present invention is preferably 0.2-1.0.

Various additives may be added to a dope containing cellulose ester via batch mixing, or alternatively, they may be added via in-line mixing using a separately prepared solution containing the additives. Specifically, particles are preferably added, partially or entirely via an in-line mixing, in order to reduce the load to a filter.

In an in-line mixing process of an additive solution, a smaller amount of cellulose ester is preferably dissolved in the dope in order to obtain a sufficiently mixed dope. The amount of cellulose ester is preferably from 1 to 10 mass parts and more preferably from 3 to 5 mass parts based on 100 mass parts of the solvent.

As a mixer for in-line addition and mixing, for example, a static mixer manufactured by Toray Engineering Co., Ltd. or a static type in-line mixer High-Mixer SWJ manufactured by Toray Industries, Inc., is preferably used.

### (Manufacturing Method of Cellulose Ester Film)

Next, the manufacturing method of the cellulose ester film of the present invention will be explained.

In the present invention, any of a cellulose ester film manufactured via a solution casting method or a cellulose ester film manufactured via a melt casting method may be preferably used.

Manufacturing of the cellulose ester film of the present invention may be performed by a process to dissolve cellulose ester and additives in a solvent to prepare a dope, a process to east the dope on an endlessly running endless metal support, a process to dry the cast dope to make a web, a process to peel the web from the metal support, a process to stretch the web or to hold the width, a process to further dry the web, and a process to wind up the finished film.

A process to prepare a dope will be now described. The concentration of cellulose ester in a dope is preferably the higher with respect to decreasing a drying load after the dope has been cast on a metal support, while filtering precision will be deteriorated due to an increased load at the time of filtering when the concentration of cellulose ester is excessively high. The concentration to balance these is preferably 10-35 weight % and more preferably 15-25 weight %.

A solvent utilized in a dope of the present invention, one type alone or at least two types in combination may be utilized, however, a good solvent and a poor solvent for cellulose ester are preferably utilized in combination with respect to manufacturing efficiency. A larger amount of a good solvent is preferable with respect to the dissolution of cellulose ester.

A preferable range of a mixing ratio of a good solvent to a poor solvent is 70-98 weight % of good solvent to 2-30 weight % of a poor solvent. As a good solvent and a poor solvent, one dissolves the cellulose ester by itself alone is defined as a good solvent and one swells or can not dissolve the cellulose ester alone is defined as a poor solvent.

Therefore, a good solvent and a poor solvent may differ depending on an average acetylation degree (an acetyl substitution degree), and, for example, when acetone is utilized as a solvent, it becomes a good solvent for an acetic ester of cellulose ester (an acetyl substitution degree of 2.4) and cellulose acetate propionate; while it becomes a poor solvent for acetic ester of cellulose (an acetyl substitution degree of 2.8) of cellulose.

A good solvent utilized in the present invention is not specifically limited, however, includes an organic halogen compound such as methylene chloride, dioxoranes, acetone, methylacetate and methyl acetoacetate. Methylene chloride and methyl acetate are specifically preferable.

Further, a poor solvent utilized in the present invention is not specifically limited, however, such as methanol, ethanol, n-butanol, cyclohexane and cyclohexanone are preferably utilized. Further, a dope is preferably contains 0.01-2 weight % of water.

The solvent removed from the film by drying in the film forming process is recovered and reused as the solvent used for dissolving a cellulose ester.

In the recovered solvent, a small amount of, for example, a plasticizer, a UV absorber, a polymer component or a monomer component may be contained. The solvent can be preferably used even when these materials are contained, or, alternatively, the solvent may be purified, if necessary, to reuse.

As a dissolution method of cellulose ester at the time of preparation of the dope described above, a general method can be employed. By a combination of heating and increased pressure, it is possible to heat up to a temperature higher than the boiling point of the solvent under an ordinary pressure.

It is preferable to dissolve the cellulose ester while stirring, by heating up to a temperature higher than the boiling point of the solvent under an ordinary pressure but in the temperature range in which the solvent does not boil under the increased pressure, because generation of a granular insoluble residue, which is called as gel or flocculates, is prevented.

Further, preferably utilized is a method, in which cellulose ester is dissolved by further adding a good solvent after having been wetted or swelled by mixing with a poor solvent.

Pressure increase may be performed by a method to introduce an inert gas such as a nitrogen gas or a method to increase vapor pressure of a solvent by heating. Heating is preferably pei formed from outside, and for example, jacket type equipment is preferable with respect to easy temperature control.

Heating temperature with addition of a solvent is preferably the higher in view of solubility of cellulose ester; however, productivity may be deteriorated due to increase of a required pressure when the heating temperature is excessively high.

The heating temperature is preferably 45-120° C. more preferably 60-110° C. and furthermore preferably 70-105° C. Further, the pressure is adjusted not to boil a solvent at the set temperature.

In addition to these, a cold dissolution method is also preferably applied, and cellulose ester can be dissolved in such as methyl acetate by this method.

Next, this cellulose ester solution is filtered by use of a suitable filter medium such as filter paper. As a filter medium, the absolute filtering precision is preferably the smaller to eliminate insoluble residue, however, there is a problem of easy clogging of a filter medium when the absolute filtering precision is excessively small.

Therefore, the absolute filtering precision of a filter medium is preferably not larger than 0.008 mm, more preferably 0.001-0.008 mm and furthermore preferably 0.003-0.006 mm.

The material of a filter medium is not specifically limited and an ordinary filter medium can be utilized, however, a filter medium made of plastic such as polypropylene and Teflon (a registered trade mark) and a filter medium made of metal such as stainless steel are preferable because of such as no release of fiber of a filter medium.

It is preferable to eliminate and reduce impurities and particularly foreign matter causing a bright spot defect, having been contained in cellulose ester as a raw material, by filtration.

Foreign matter causing bright spot defects means a spot (foreign matter) which is visible due to light leak, when two sheets of polarizing plates, between which an optical film is placed, are arranged in a crossed nicols state, and light is irradiated from one of the polarizing plate side to be observed from the other polarizing plate side. The number of bright spots having a diameter of not less than 0.01 mm is preferably not more than 200 spots/cm².

The number of bright spots having a diameter of not less than 0.01 mm is more preferably not more than 100 spots/cm², further more preferably not more than 50 spots/cm², still more preferably 0-10 spots/cm². Further, the number of a bright spot defect of not larger than 0.01 mm is also preferably the smaller.

Filtering of a dope can be performed by an ordinary method, however, a method to filter while heating at a temperature of not lower than a boiling point of a solvent at ordinary pressure and of not to boil the solvent under an increased pressure is preferable because of small increase of a difference of filter pressures between before and after filtering (referred to as a pressure difference).

The preferable temperature is 45-120° C., more preferably 45-70° C. and furthermore preferably 45-55° C.

Filter pressure is preferably the lower. The filter pressure is preferably not higher than 1.6 MPa, more preferably not higher than 1.2 MPa and furthermore preferably not higher than 1.0 MPa.

Casting of a dope will now be explained.

A metal support in a casting process is preferably those the surface of which is mirror finished, and a stainless steel belt or a drum made of castings, the surface of which is plating finished, is utilized.

The cast width can be set to 1-4 m. The surface temperature of a metal support in a cast process is from −50° C. to a temperature lower than the boiling point of a solvent. It is preferable the temperature is the higher since a drying speed of a web can be set faster; however, excessively high temperature may sometimes cause foaming of a web or deterioration of flatness.

The support temperature is preferably 0-55° C. and more preferably 25-50° C. It is also a preferable method to make a web gelled by cooling and to peel off the web from a drum while the web contains a larger amount of residual solvent.

The method to control the temperature of a metal support is not specifically limited; however, there are a method to blow a hot wind or a cold wind on the web and a method to make hot water contact the rear side of a metal plate. A method to utilize hot water is preferable because time required to make a metal support become a constant temperature is short due to more efficient heat conduction. In the case of employing a hot wind, a wind of a temperature higher than the aimed temperature may be employed.

To provide a good flatness of a cellulose ester film, the residual solvent amount at the time of peeling off a web from a metal support is preferably 10-150 mass %, more preferably 20-40 mass % or 60-130 mass % and specifically preferably 20-30 mass % or 70-120 mass %.

In the present invention, a residual solvent amount is defined by the following equation.

Residual solvent amount (mass %){(M−N)/N}×100

Herein, M is a weight of a sample picked at an arbitrary time during or after manufacturing of a web or film and N is a weight after heating M at 115° C. for 1 hour.

Further, in a drying process of a cellulose ester film, a web is preferably peeled off from a metal support and fiwther dried to make a residual solvent amount of not more than 1 mass %, more preferably not more than 0.1 mass % and specifically preferably 0-0.01 mass %.

In a film drying process, a roll drying method (in which a web is dried while being alternately passed through many rolls which are arranged up and down) or a method to dry a web while being transported by a tenter method will be applied.

To prepare cellulose ester film of the present invention, it is specifically preferable that a web is stretched in the width direction (the lateral direction) by means of a tenter method to grip the both edges of the web by such as clips. The peeling tension is preferably 300 N/m or less.

A means to dry a web is not specifically limited, and it can be generally performed by such as a hot wind, infrared rays, a heat roll and microwaves, however, preferably performed by a hot wind in view of convenience.

A drying temperature in a drying process of a web is preferably raised step-wise in a range of 40-200° C.

The layer thickness of the cellulose ester film is not specifically limited; however, a layer thickness of 10 to 200 μm is applied. The layer thickness is specifically preferably 10-100 μm and furthermore preferably 20 to 60 μm.

The cellulose ester film of the present invention has a width of 1 to 4 m. The width is preferably 1.4 to 4 m and specifically preferably 1.6 to 3 m. When the width exceeds 4 m, the transportation becomes difficult.

In order to obtain the retardation values Ro and Rt desired in the present invention, it is preferable that the cellulose ester film has the constitution of the present invention and, further, is subjected to refractive index control by means of control of conveyance tension or stretching.

The retardation value can be varied by increasing or decreasing the tension along the longitudinal direction.

It is also possible to perform uniaxial stretching or sequential or simultaneous biaxial stretching in the longitudinal direction of the film (the cast direction) and in the direction perpendicular thereto in the film plane, namely, in the width direction.

The stretching ratios in the biaxial directions perpendicular to each other are preferably set to finally 0.8 to 1.5 times in the cast direction and 1.1 to 2.5 times in the width direction, and more preferably set to 0.8 to 1.0 times in the cast direction and 1.2 to 2.0 times in the width direction.

The stretching temperature is preferably 120° C. to 200° C., more preferably 150° C. to 200° C., still more preferably higher than 150° C. and not higher than 190° C.

It may be preferable to stretch a film under the condition where the content of the residual solvent in the film is 20 to 0%, and more preferably 15 to 0%.

More concretely, the film is preferably stretched under the condition that the content of the residual solvent is 11% at 175° C., or the content of the residual solvent is 2% at 155° C. Otherwise, the content of the residual solvent is 11% at 160° C., or the content of the residual solvent is lower than 1% at 160° C.

A method to stretch a web is not specifically limited. For example, listed a method to stretch in the longitudinal direction by making a circumferential speed difference among plural rolls and utilizing the roll circumferential speed difference among them, a method to stretch in the longitudinal direction by fixing the both edges of a web with clips or pins and widening the intervals between clips and pins toward the proceeding direction, a method to stretch by widening similarly along the width direction, or a method to stretch in the both of longitudinal and width directions by simultaneously widening along the longitudinal and width directions. Of course, these methods may be used in combination.

In a so-called tenter method, it is preferable that a smooth stretching can be performed by driving the clip portion by a linear drive method which reduces risk to such as break.

It is preferable to perform the width holding or stretching in the width direction by a tenter, which may be either a pin tenter or a clip tenter.

The slow axis or the fast axis of the cellulose ester film of the present invention preferably is present in a film plane and θ1 is preferably not less than −1° and not more than +1°, and more preferably not less than −0.5° and not more than +0.5°, provided that θ1 represents the angle against the casting direction.

This θ1 can be defined as an orientation angle, and measurement of θ1 can be performed by use of automatic birefringent meter KOBRA-21ADH (Oji Scientific Instruments). To satisfy the above-described relationships by θ1 can contributes to obtain a high luminance and to restrain or prevent light leak, and to obtain faithful color reproduction in a color liquid display.

### (Physical Properties of Cellulose Ester Film)

The moisture permeability of the cellulose ester film according to the present invention is preferably 300 to 1,800 g/m².24 h, more preferably 400 to 1,500 g/m².24 h and specifically preferably 400 to 1300 g/m².24 h at 40° C., 90% RH. The moisture permeability can be measured according to a method described in JIS Z 0208.

The elongation percentage of the cellulose ester film according to the present invention is preferably 10 to 80% and more preferably 20 to 50%.

The visible light transmittance of the cellulose ester film according to the present invention is preferably not less than 90% and more preferably not less than 93%.

The haze of the cellulose ester film according to the present invention is preferably less than 1% and specifically preferably 0 to 0.1%.

Further, if a liquid crystal layer is coated on the cellulose ester film according to the present invention, retardation values extending over a more wide range may be obtained.

### (Polarizing Plate)

The cellulose ester film which is a retardation film of the present invention may be applied to a polarizing plate protective film of a polarizing plate and to a liquid crystal display employing the polarizing plate.

A polarizing plate of the present invention is characterized by being a polarizing plate constituted of a polarizer, pasted with the aforesaid cellulose ester film according to the present invention as a polarizing protective film on at least one surface. A liquid crystal display device of the present invention is characterized in that a polarizing plate according to the present invention is pasted up on at least one liquid crystal cell surface via an adhesive layer.

The polarizing plate of the present invention can be prepared by an ordinary method. The cellulose ester film according to the present invention, the polarizer side of which is subjected to an alkaline saponification treatment, is preferably pasted up on at least one surface of a polarizer which has been prepared by immersion stretching in an iodine solution by use of a completely saponificated type polyvinyl alcohol aqueous solution.

On the other surface, said optical compensation film may be utilized or another polarizing plate protective film may be utilized.

For example, a cellulose ester film (such as Konica Minolta TAC KC8UX, KC5UX, KC8UCR3, KC8UCR4, KC8UCR5, KC8UY, KC4UY, KC4UE, KC8UE, KC8UY-HA, KC8UX-RHA, KC8UXW-RHA-C, KC8UXW-RHA-NC, and KC4UXW-RHA-NC manufactured by Konica Minolta Opto. Inc.) available on the market is also preferably utilized.

Onto the polarizing plate protective film used for the surface side of a display unit, it is desirable to provide an antireflection layer, an antistatic layer, an antifouling layer, or a back coat layer besides an antiglare layer or a clear hard coat layer.

A polarizer as a primary constitution element is an element to pass light of a polarized wave plane of a predetermined direction, and a typical polarizer known at present is polyvinyl type polarizing film, which includes polyvinyl alcohol film dyed with iodine and one dyed with dichroic dye.

As a polarizer, utilized is one in which a polyvinyl alcohol aqueous solution is cast, and the cast film is uniaxially stretched and dyed, or is uniaxially stretched after having been dyed, preferably followed by being subjected to a durability treatment with a boron compound. The layer thickness of a polarizer is preferably 5 to 30 μm and specifically preferably 10 to 20 μm.

Further, ethylene modified polyvinyl alcohol which is described in such as JP-A 2003-248123 and JP-A 2003-342322 and has an ethylene unit content of 1 to 4 mol %, a polymerization degree of 2,000 to 4,000 and a saponification degree of 99.0 to 99.99 mol % is also preferably utilized.

Among them, ethylene modified polyvinyl alcohol having a hot water breaking temperature of 66 to 73° C. is preferably utilized.

Further, a difference of hot water breaking temperature between two points remote from each other by 5 cm in the film TD direction is preferably not more than 1° C. and more preferably not more than 0.5° C., in order to reduce color spottiness.

A polarizer utilizing this ethylene modified polyvinyl alcohol film is excellent in polarizing ability and durability, as well as exhibits few color spottiness, and is specifically preferably applied in a large size liquid crystal display device.

A polarizer prepared in the above manner, generally on the both surface or one surface of which protective film is pasted up, is utilized as a polarizing plate. An adhesive employed at the time of paste up includes a PVA type adhesive and an urethane type adhesive, however, among them preferably utilized is a PVA type adhesive.

### (Liquid Crystal Display)

By using the polarizing plate of the present invention for a liquid crystal display, various kinds of the liquid crystal displays of the present invention excellent in visibility can be produced.

The the cellulose ester film can be used for liquid crystal displays with various drive modes, such as STN, TN, OCB, HAN, VA (MVA, PVA), IPS, and OCB.

It is preferable to use for a VA (MVA, PVA) mode liquid crystal display.

Especially, even if a liquid crystal display has a large screen more than 30 type, it is possible to obtain a liquid crystal display in which there are few environmental variations, light leakage is reduced, and visibility, such as color tone unevenness and front contrast is excellent.

### EXAMPLE

Hereafter, the present invention will be explained with reference to examples, however, the present invention is not limited thereto.

### Example 1

### (Example According to the First Embodiment)

### <Production of Cellulose Ester Film 101>

### <Particle Dispersion Liquid1>

| | |
|---|---|
| Particle (Aerosil R972V | 11 parts by mass |
| manufactured by Japan Aerosil) | |
| Ethanol | 89 parts by mass |

The substances listed above were agitated and mixed by a dissolver for 50 minutes and then dispersed by the use of Manton Gaulin.

### <Particle Addition Liquid 1>

The particle dispersion liquid 1 was slowly added into a solution tank storing methylene chloride, while being agitated sufficiently. Further, the solution was dispersed by an at-righter so that the particle size of secondary particles became a predetermined size. The resultant solution was filtered by the use of Fine Met NF manufactured by Nippon Seisen Co., Ltd., whereby particle addition liquid 1 was prepared.

| | |
|---|---|
| Methylene chloride | 99 parts by mass |
| Particle dispersion liquid 1 | 5 parts by mass |

A main dope liquid of the following composition was prepared. First, methylene chloride and ethanol were added to a pressure solution tank. Cellulose ester A and B were supplied into the pressure solution tank storing a solvent while being agitated. Further, it was dissolved completely while being heated and agitated. The resultant liquid was filtered by the use of Azumi filter paper No. 244 manufactured by Azumi Filter Paper Co., Ltd., whereby the main dope liquid was prepared.

### <Composition of the Main Dope Liquid>

| | |
|---|---|
| Methylene chloride | 340 parts by mass |
| Ethanol | 64 parts by mass |
| Cellulose ester A of the present invention | 100 parts by mass |
| Polyester compound 14 of the present invention | 6.5 parts by mass |
| Saccharide ester compound 3 of the present | 6.0 parts by mass |
| invention | |
| Particle addition liquid 1 | 1 parts by mass |

The above substances were put into a sealed container and dissolved while being agitated, whereby a dope liquid was prepared. Subsequently, by the use of an endless belt type casting apparatus, the dope liquid was uniformly cast on a stainless steel belt support at the temperature of 33° C. with a 1500 mm width. The temperature of the stainless steel belt was controlled at 30° C.

The solvent was evaporated on the stainless belt support until the remaining solvent amount in the cast film became 75%, and then the cast film was peeled from the stainless steel belt support with a peeling force of 130 N/m.

The peeled cellulose ester film was stretched 36% in the width direction by the use of a tenter under the application of heat of 150° C. The residual solvent at the time of starting the stretching was 15%.

Subsequently, the drying of the cellulose ester film was completed while the cellulose ester was being conveyed through a drying zone convey with many rolls. A drying temperature was 130° C. and conveying tension was made 100 N/m.

As mentioned above, cellulose ester film 101 with a dried film thickness of 40 μm was obtained. Hereafter, cellulose ester films 102 to 115 were produced almost in the similar manner except that the plasticizer further was added into cellulose ester films 109 and 111 and the kind of solvents and the film thickness, and the stretching ratio were changed as shown in Table 2.

Plasticizer A: Triphenyl phosphate

Plasticizer B: Ethylphthalyl ethyl glycolate

Plasticizer C: Trimethylolpropanebenzonate ester

Moreover, films 201 to 207 were produced as a comparative sample.

TABLE 1

| | | Total acyl |
|---|---|---|
| Cellulose ester | | substitution |
| (CE) | Acyl substitution degree | degree |
| A | Acetyl group: 1.6 Propionyl group: 0.9 | 2.5 |
| B | Acetyl group: 1.5 Propionyl group: 0.9 | 2.4 |
| C | Acetyl group: 1.9 Propionyl group: 0.8 | 2.7 |

For each obtained sample, retardation values at respective wavelength, haze and scattered light intensity were determined by the methods described below.

TABLE 2

| | Dope composition | | | | | | | | | | | | | | |
|---|---|---|---|---|---|---|---|---|---|---|---|---|---|---|---|
| | | Formula (I) | | | | | | | | | | | | | |
| | | Polyester | | Saccharide | | | Manufacturing condition | | | Optical property | | | Integrated scattered | | |
| Cellulose | | compound | | ester compound | | | | Film | Stretching | Retardation | | | light intensity | | |
| ester film | CE | | % by | | % by | Plasticizer | Stretching | thickness | temperature | Ro | Rt | Haze | Differ- | Hori- | Ver- |
| No. | Kind | Kind | mass | Kind | mass | (% by mass) | ratio | (μm) | (° C.) | (nm) | (nm) | (%) | ence | zontal | tical |
| 101 | A | 14 | 6.5 | 3 | 6.0 | — | 1.36 | 40 | 155 | 50 | 125 | 0.15 | 0.07 | 0.55 | 0.48 |
| 102 | A | 14 | 4.5 | 3 | 8.0 | — | 1.35 | 39 | 150 | 52 | 125 | 0.13 | 0.07 | 0.56 | 0.49 |
| 103 | B | 14 | 6.5 | 3 | 6.0 | — | 1.37 | 42 | 155 | 50 | 120 | 0.15 | 0.05 | 0.58 | 0.53 |
| 104 | C | 14 | 6.5 | 3 | 6.0 | — | 1.45 | 50 | 145 | 50 | 125 | 0.14 | 0.07 | 0.58 | 0.51 |
| 105 | A | 17 | 6.5 | 3 | 6.0 | — | 1.36 | 40 | 155 | 51 | 123 | 0.15 | 0.08 | 0.60 | 0.52 |
| 106 | A | 17 | 4.5 | 3 | 8.0 | — | 1.35 | 38 | 150 | 53 | 125 | 0.16 | 0.09 | 0.65 | 0.56 |
| 107 | A | 17 | 6.5 | 4 | 6.0 | — | 1.40 | 42 | 160 | 55 | 125 | 0.17 | 0.09 | 0.55 | 0.46 |
| 108 | A | 16 | 6.5 | 3 | 6.0 | — | 1.45 | 50 | 172 | 62 | 140 | 0.17 | 0.04 | 0.59 | 0.55 |
| 109 | A | 16 | 4.5 | 3 | 8.0 | A(2.5) | 1.40 | 50 | 160 | 60 | 120 | 0.19 | 0.06 | 0.61 | 0.55 |
| 110 | A | 16 | 6.5 | 12 | 6.0 | — | 1.42 | 50 | 165 | 60 | 124 | 0.15 | 0.05 | 0.55 | 0.50 |
| 111 | A | 1 | 6.5 | 3 | 6.0 | B(2.5) | 1.35 | 50 | 160 | 52 | 115 | 0.18 | 0.06 | 0.61 | 0.55 |
| 112 | A | 1 | 6.5 | 3 | 6.0 | C(2.5) | 1.37 | 50 | 160 | 52 | 115 | 0.18 | 0.06 | 0.61 | 0.55 |
| 113 | A | 1 | 6.5 | 3 | 6.0 | — | 1.36 | 47 | 180 | 52 | 125 | 0.27 | 0.03 | 0.58 | 0.55 |
| 114 | A | 13 | 6.5 | 3 | 6.0 | — | 1.50 | 40 | 170 | 60 | 130 | 0.15 | 0.04 | 0.59 | 0.55 |
| 115 | A | 13 | 6.5 | 3 | 6.0 | — | 1.25 | 48 | 170 | 60 | 130 | 0.15 | 0.09 | 0.64 | 0.55 |
| 116 | A | 15 | 6.5 | 5 | 6.0 | — | 1.45 | 50 | 155 | 60 | 125 | 0.15 | 0.07 | 0.62 | 0.55 |
| 201 | A | — | — | 5 | 15.1 | — | 1.40 | 40 | 130 | 59 | 119 | 0.70 | 0.30 | 1.20 | 0.90 |
| 202 | A | 1 | 6.0 | — | — | — | 1.35 | 50 | 130 | 60 | 135 | 0.85 | 1.05 | 2.00 | 0.95 |
| 203 | A | — | — | 3 | 5.0 | A(2.5) | 1.45 | 50 | 130 | 60 | 145 | 1.05 | 1.45 | 2.40 | 0.95 |
| 204 | A | 1 | 15.1 | — | — | — | 1.2 | 50 | 140 | 81 | 201 | 0.5 | 0.90 | 2.40 | 1.50 |
| 205 | C | 1 | 10 | 3 | 5.5 | | 1.2 | 48 | 140 | 85 | 190 | 0.75 | 0.70 | 3.60 | 2.90 |
| 206 | B | 2 | 5.1 | 5 | 10 | B(2.5) | 1.2 | 40 | 140 | 85 | 180 | 0.8 | 0.80 | 2.90 | 2.10 |
| 207 | B | 3 | 10 | 5 | 5.1 | C(2.5) | 1.3 | 40 | 135 | 60 | 145 | 1.05 | 0.70 | 2.50 | 1.80 |

### <<Measurement of Retardation Ro and Rt>>

Samples were cut out with a size of 35 mm×35 mm from the obtained films, and moisture conditioned under an ambience of 25° C., 55% RH. Retardation values were measured in a vertical direction by the use of an automatic birefringence analyzer (KOBRA-21ADH manufactured by Oji Scientific Instruments) at a wavelength of 590 nm for each samples, and also retardation values were measured with the same ways on the condition that the film surface of each samples was slanted, then retardation values were calculated from extrapolation values of these measured retardation values.

### <<Haze>>

According to JIS K-6714, the haze was measured by the use of a haze meter 1001 DP type manufactured by Nippon Denshoku.

### <<Integrated Scattered Light Intensity>>

The scattered light intensity was measured by the use of a goniophotometer, type: GP-1-3D, manufactured by Optic corporation (a light source was a 12V50W halogen lamp, and a light receiving section was a photomultiplier tubes (Photomul, Hamamatsu photonics R636-10)).

The integrated value was determined by summing up the integrated scattered light intensities determined in every 1° in the range of 130°±35°.

The sample was measured on the condition where the slow axis of the film was fixed horizontally and vertically to the sample stand respectively.

It is clear that the retardation films 101-106 of the present invention are superior to the comparative films 201-207.

### Example 2

### <Preparation of Polarizing Plate>

A polyvinyl alcohol film having a thickness of 120 μm was uniaxially stretched (temperature: 110° C., stretching ratio: 5 times).

The film was immersed in an aqueous solution of 0.075 g iodine, 5 g potassium iodide, and 100 g water for 60 seconds, and then immersed in a 68° C. aqueous solution of 6 g potassium iodide, 7.5 g boric acid and 100 g water. The film was washed and dried to obtain a polarizer film.

Next, the polarizer film and each of the cellulose ester films 101 to 207 of the present invention were pasted onto the front side and a Konica Minolta TAC KC4UY (cellulose ester film manufactured by Konica Minolta Opto. Inc. was pasted on the back side in accordance with the following steps 1 to 5, whereby polarizing plates were prepared.

Step 1: A cellulose ester film was immersed for 90 seconds in 2 mol/L of sodium hydroxide solution at 60° C. and then washed and dried, whereby a cellulose ester film the side of which to be pasted to a polarizing element was saponified was obtained.

Step 2: The polarizer film was immersed in a tank of polyvinyl alcohol adhesive having a solid content of 2 mass % for 1 to 2 seconds.

Step 3: Excess adhesive attached to the polarizer film in Step 2 was gently wiped off and then the polarizer film was placed on the cellulose ester films processed in Step 1.

Step 4: Each of the cellulose ester films 101 to 207 and the polarizer film which were stacked in Step 3, and a cellulose ester films on the back side were pasted together at a pressure of 20-30 N/cm² and a conveyance speed of approximately 2 m/minute.

Step 5: The samples in which the polarizing cellulose ester films 101 to 207, and Konica Minolta TAC KC4Uy were prepared in Step 4 were dried for 2 minutes in a dryer at 80° C., whereby polarizing plates 101 to 115 of the present invention and comparative polarizing plates 201 to 207 were prepared.

### <Production of a Liquid Crystal Display>

A liquid crystal panel to perform viewing angle measurement was produced as follows, and the characteristics as a liquid crystal display were evaluated.

The polarizing plates preliminarily pasted on both sides of a 40 type display KLV-40J3000 manufactured by SONY were removed, and the polarizing plates 101 to 115, 201 to 207 which were produced as mentioned above were pasted onto both sides of a glass surface of a liquid crystal cell respectively.

At this time, the polarizing plates were pasted in such a direction that the plane of the cellulose ester film of the present invention became the liquid crystal cell side and the absorption axis was directed to the same direction as the preliminarily pasted polarizing plate, whereby the liquid crystal displays 101 to 115 of the present invention and the comparative liquid crystal displays 201 to 207 were produced respectively.

These liquid crystal displays were evaluated in terms of color hue fluctuation and front contrast. Results are shown in Table 3.

### <<Evaluation of Color Hue Fluctuation>>

The color hue fluctuation was measured by use of a measuring device (EZ-Contrast 160D manufactured by ELDIM) for each of the liquid crystal displays produced as mentioned above as follows. In CIE 1976 UCS coordinate, and the maximum color hue fluctuation (A utv) in the upward and downward direction (from upward 80° to downward 80° from the direction of the normal line of the display) was compared.

### <<Evaluation of Front Contrast>>

In the environment of 23° C., 55% RH, after the backlight of each of the liquid crystal displays was continuously lighted for one week, the measurement was performed. EZ-Contrast 160D manufactured by ELDIM was used for the measurement in such a way that the luminance from the normal line direction of the display screen was measured on a white display mode and a black display mode of the liquid crystal display, and the ratio between the luminance values on the white display mode and the black display mode was observed as the front contrast.

Front contrast=(luminance on the white display mode measured from the normal line direction of the display device)/(luminance on the black display mode measured from the normal line direction of the display device)

TABLE 3

| | Color hue | | |
|---|---|---|---|
| Liquid crystal | fluctuation | Front | |
| display No. | (Δu′v′) | contrast | Remarks |
| 101 | 0.06 | 1170 | Inventive |
| 102 | 0.08 | 1150 | Inventive |
| 103 | 0.07 | 1120 | Inventive |
| 104 | 0.08 | 1120 | Inventive |
| 105 | 0.07 | 1130 | Inventive |
| 106 | 0.05 | 1170 | Inventive |
| 107 | 0.05 | 1140 | Inventive |
| 108 | 0.06 | 1120 | Inventive |
| 109 | 0.06 | 1110 | Inventive |
| 110 | 0.06 | 1150 | Inventive |
| 111 | 0.06 | 1150 | Inventive |
| 112 | 0.07 | 1150 | Inventive |
| 113 | 0.08 | 1150 | Inventive |
| 114 | 0.07 | 1120 | Inventive |
| 115 | 0.07 | 1170 | Inventive |
| 116 | 0.06 | 1150 | Inventive |
| 201 | 0.16 | 950 | Comparative |
| 202 | 0.18 | 950 | Comparative |
| 203 | 0.18 | 930 | Comparative |
| 204 | 0.15 | 970 | Comparative |
| 205 | 0.17 | 980 | Comparative |
| 206 | 0.16 | 950 | Comparative |
| 207 | 0.15 | 980 | Comparative |

The results shown in Table 3 show that Liquid crystal displays 101-116 each exhibit excellent color hue fluctuation and front contrast.

What is claimed is:

1. A retardation film exhibiting a difference between:
an integrated scattered light intensity determined when the retardation film is mounted on a sample stand of a goniophotometer so that a slow axis of the retardation film is horizontally aligned; and
an integrated scattered light intensity determined when the retardation film is mounted on the sample stand so that the slow axis of the retardation film is vertically aligned, of 0.1 or less, wherein each integrated scattered light intensity is determined by integrating scattered light intensities at positions in the range of 95-165° from a light source in a scattered light profile of the goniophotometer in which an incident light angle onto the retardation film is 90°.

2. The retardation film of claim 1, wherein the retardation film is a cellulose ester film comprising at least one of an aromatic terminal polyester compound represented by Formula (I) and an ester compound having one or more but 12 or less of at least one of a pyranose structure and a franose structure, provided that all or a part of OH groups in the structure are esterified,
B-(G-A)n-G-B Formula (I)
wherein B represents an aryl carboxylic acid residue, G represents an alkylene glycol residue having 2-12 carbon atoms, an aryl glycol residue having 6-12 carbon atoms or an oxyallcylene glycol residue having 4-12 carbon atoms, A represents an alkylene dicarboxylic acid residue having 4-12 carbon atoms or an aryl dicarboxylic acid residue having 6-12 carbon atoms, n represents an integer of 1 or more.
